(19) United States
(12) Patent Application Publication
(10) Pub. No.: US 2025/0086567 A1
(43) Pub. Date: Mar. 13, 2025

(54) TRANSPORTATION AND DELIVERY PLANNING APPARATUS AND METHOD

(71) Applicant: Hitachi, Ltd., Tokyo (JP)

(72) Inventors: Miho ISOKAWA, Tokyo (JP); Junko HOSODA, Tokyo (JP); Kazuya UYAMA, Tokyo (JP); Satoshi NAGAHARA, Tokyo (JP); Yui KAZAWA, Tokyo (JP)

(21) Appl. No.: 18/776,114

(22) Filed: Jul. 17, 2024

(30) Foreign Application Priority Data
Sep. 7, 2023 (JP) 2023-145622

(51) Int. Cl. G06Q 10/083; G06Q 10/0631

(52) U.S. Cl. CPC G06Q 10/083; G06Q 10/06316

(57) ABSTRACT

A transportation and delivery planning apparatus and method suppresses the delayed delivery of packages and is designed to: create an assignment proposal to assign each of transportation delivery instructions to each of service trips for which a service plan was created in advance; devise a sorting plan for packages at a relay base on the basis of the created assignment proposal for each created transportation delivery instruction; calculate task time of a sorting task at the relay base according to the sorting plan and evaluate a transportation delivery plan based on a calculation result; and change the sorting plan or modify the assignment proposal, based on an evaluation result of the transportation delivery plan, so that the sorting task for the respective packages will be completed at the relay base before a departure of the service trip for a connecting destination assigned to each of the transportation delivery instructions.

### CROSS-REFERENCE TO RELATED APPLICATION

The present application claims priority from Japanese application JP2023-145622, filed on Sep. 7, 2023, the content of which is hereby incorporated by reference into this application.

### TECHNICAL FIELD

The present invention relates to a transportation and delivery planning apparatus and method and is suited for application to, for example, a transportation and delivery planning apparatus for devising a transportation delivery plan(s) for packages that go through relay bases.

### BACKGROUND ART

In recent years, with the expansion of the electronic commerce (EC) market, the volume of transported and delivered packages has been increasing year by year. With a transportation and delivery service, a reference date is set on which the relevant package will arrive at its destination. In some cases, a delivery deadline may be designated upon a customer's request. It is important to observe the delivery deadline because it will affect the relevant transportation delivery company's credibility.

A transportation delivery company devises a service trip diagram that specifies the number of service trips between distribution bases such as collection and delivery bases and relay bases, arrival and departure times of day of transportation delivery vehicles at each distribution base, driving routes, etc., in advance and makes arrangements of transportation delivery resources that serve as subjects or means of shipment, transportation, and delivery such as transportation delivery vehicles, shipping workers, and drivers. Moreover, in response to transportation delivery requests for packages from customers, the transportation delivery company devises transportation delivery plans and transports and delivers the packages according to the devised transportation delivery plans.

Incidentally, regarding the devising of the transportation delivery plans, for example, PTL 1 discloses a method for efficiently creating plans for transshipping packages between transportation trips to achieve improved transport efficiency and serviceability without resulting in significant changes in the transportation plans between bases.

Moreover, PTL 2 discloses that: regarding management of delivering packages, a plurality of relay station candidates capable of transshipping packages from arriving vehicles to delivery vehicles are set: an index is created to indicate the degree of conditions included in a task until the packages are transshipped at the relay station candidate; and a relay station is decided from among the relay station candidates based on the created index.

### CITATION LIST

### Patent Literature

PTL 1: Japanese Patent No. 03586822
PTL 2: Japanese Patent Application Laid-Open (Kokai) Publication No. 2022-138271

### SUMMARY OF THE INVENTION

### Problems to be Solved by the Invention

However, conventionally, when devising transportation delivery plans, task time at a relay base has not been often considered. Therefore, the problem in actual operations is that some packages fail to be loaded into connecting service trips due to, for example, a delay in the task at the relay base, which results in delayed delivery of the packages.

The present invention was devised in consideration of the above-described circumstance and aims at proposing a transportation and delivery planning apparatus and method capable of suppressing the occurrence of delayed delivery of packages.

### Means to Solve the Problems

In order to solve the above-described problem, there is provided according to the present invention a transportation and delivery planning apparatus for devising a transportation delivery plan to assign transportation delivery instructions regarding packages to service trips, wherein the transportation and delivery planning apparatus includes: an assignment proposal creation unit that creates an assignment proposal to assign each of the transportation delivery instructions to each of the service trips for which a service plan was created in advance; a sorting planning unit that devises a sorting plan for the packages at a relay base on the basis of the assignment proposal for each transportation delivery instruction created by the assignment proposal creation unit; and an evaluation determination unit that calculates task time of a sorting task at the relay base according to the sorting plan and evaluates the transportation delivery plan based on a calculation result, wherein the sorting planning unit changes the sorting plan or the assignment proposal creation unit modifies the assignment proposal, based on an evaluation result of the evaluation determination unit, so that the sorting task for the respective packages will be completed at the relay base before a departure of the service trip for a connecting destination assigned to each of the transportation delivery instructions.

Moreover, the present invention relates to a transportation and delivery planning method a transportation and delivery planning method executed by a transportation and delivery planning apparatus for devising a transportation delivery plan to assign transportation delivery instructions regarding respective packages to service trips, wherein the transportation and delivery planning method includes: a first step of creating an assignment proposal to assign each of the transportation delivery instructions to each of the service trips for which a service plan was created in advance; a second step of devising a sorting plan for the packages at a relay base on the basis of the created assignment proposal for each transportation delivery instruction; and a third step of calculating task time of a sorting task at the relay base according to the sorting plan and evaluating the transportation delivery plan based on a calculation result, a fourth step of changing the sorting plan or modifying the assignment proposal, based on an evaluation result of the transportation delivery plan, so that the sorting task for the respective packages will be completed at the relay base before a departure of the service trip for a connecting destination assigned to each of the transportation delivery instructions.

According to the transportation and delivery planning apparatus and method of the present invention, it is possible to devise the transportation delivery plan(s) in consideration of the task time at the relay base and to prevent the occurrence of the situation where packages may fail to be loaded into connecting service trips due to any delay in the task at the relay base.

### Advantageous Effects of the Invention

According to the present invention, it is possible to realize a transportation and delivery planning apparatus and method for suppressing the occurrence of any delayed delivery of packages.

### BRIEF DESCRIPTION OF DRAWINGS

FIG. 1 is a block diagram illustrating the configuration of a transportation delivery planning system according to this embodiment;

FIG. 2 is a conceptual diagram illustrating an example of a service plan;

FIG. 3 is a diagram illustrating a structure example of a service trip information table;

FIG. 4A is a diagram illustrating an example of a charter system fare table and FIG. 4B is a diagram illustrating an example of a unit-based fare table;

FIG. 5 is a diagram illustrating an example of a base information table;

FIG. 6A is a diagram illustrating a structure example of a first sorting ability information table and FIG. 6B is a diagram illustrating a structure example of a second sorting ability information table;

FIG. 7 is a diagram illustrating a structure example of a transportation delivery instruction information table;

FIG. 8 is a diagram illustrating a structure example of an assignment information table;

FIG. 9 is a diagram illustrating a structure example of a priority index information table;

FIG. 10 is a diagram illustrating a structure example of a relay information table;

FIG. 11 is a diagram illustrating a structure example of a sorting plan information table;

FIG. 12 is a diagram illustrating a screen configuration example of a transportation delivery planning instruction screen;

FIG. 13 is a diagram illustrating a display example of a popup;

FIG. 14 is a diagram illustrating another screen configuration example of the transportation delivery planning instruction screen;

FIG. 15 is a flowchart illustrating a processing sequence of transportation delivery planning processing;

FIG. 16 is a flowchart illustrating a processing sequence of transportation delivery instruction assignment proposal creation processing;

FIG. 17 is a flowchart illustrating a processing sequence of first relay base sorting planning processing;

FIGS. 18A to 18C are diagrams for explaining the first relay base sorting planning processing;

FIGS. 19A to 19B are conceptual diagrams for explaining the first relay base sorting planning processing;

FIG. 20 is a flowchart illustrating a processing sequence of second relay base sorting planning processing;

FIG. 21 is a conceptual diagram for explaining the first relay base sorting planning processing; and

FIG. 22 is a flowchart illustrating a processing sequence of transportation delivery instruction assignment proposal modification processing.

### DESCRIPTION OF EMBODIMENTS

An embodiment of the present invention will be described below in detail with reference to the drawings.

Incidentally, the embodiment described below is an example for explaining the present invention and some omissions and simplification are made as appropriate for clarity of explanation. The present invention can be implemented in various other forms. Unless otherwise limited, each constituent element may be singular or plural.

The location, size, shape, range, and so on of each constituent element indicated in the drawings may not represent the actual location, size, shape, range, etc. in order to facilitate understanding of the invention. Therefore, the present invention is not necessarily limited to the locations, sizes, shapes, ranges, etc. disclosed in the drawings.

Examples of various types of information may be described in expressions such as “table,” “list,” and “queue,” but the various types of information may be expressed in other data structures. For example, various types of information such as an “XX table,” an “XX list,” and an “XX queue” may be expressed as “XX information.” When explaining identification information, expressions such as “identification information,” “identifier,” “name,” “ID,” and “number” are used, but they can be replaced with each other.

If there are a plurality of constituent elements having the same or similar function, the same reference numeral with different subscripts may be used. Moreover, if it is unnecessary to distinguish between these multiple constituent elements, they may be described by omitting the subscripts.

In the embodiment, processing performed by executing a program may be described. Under this circumstance, a computer causes a processor (such as a CPU or a GPU) to executes a program(s) and performs processing defined by the program(s) while using storage resources (such as a memory), interface devices (such as communication ports), and so on. Therefore, a subject of the processing performed by executing the program may be the processor.

Similarly, the subject of the processing performed by executing the program may be a controller, an apparatus, a system, a computer, or a node which has the processor. The subject of the processing performed by executing the program may be an arithmetic unit and may include a dedicated circuit for performing specific processing. Under this circumstance, the dedicated circuit is, for example, an FPGA (Field Programmable Gate Array), an ASIC (Application Specific Integrated Circuit), or a CPLD (Complex Programmable Logic Device).

The program may be installed to the computer from a program source. The program source may be, for example, a program distribution server or a computer-readable storage medium. If the program source is the program distribution server, the program distribution server may include a processor and a storage resource for storing the program to be distributed, and the processor of the program distribution server may distribute the target program to be distributed to other computers. Moreover, in the embodiment, two or more programs may be implemented as one program or one program may be implemented as two or more programs.

### (1) Configuration of Transportation Delivery Planning System According to this Embodiment

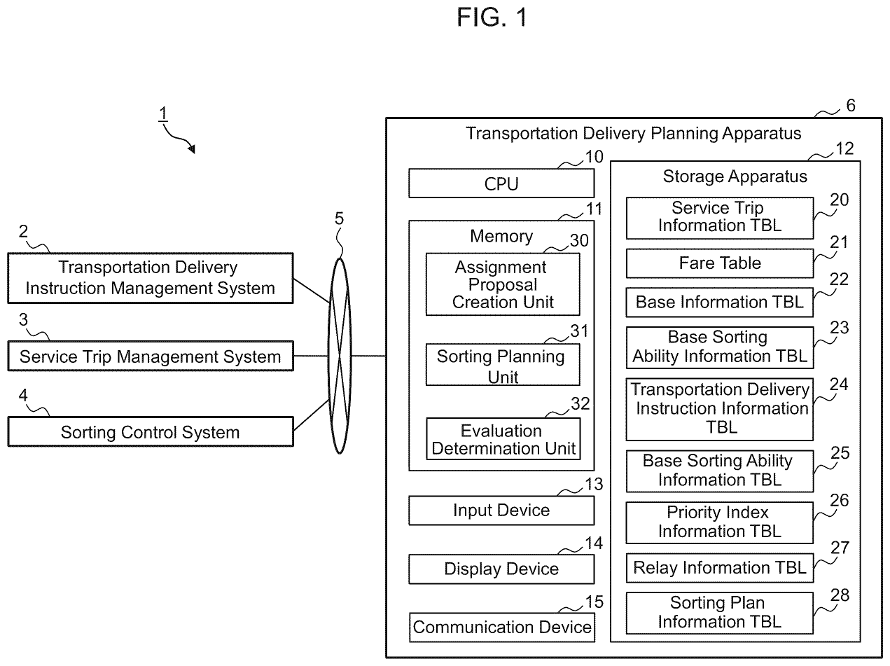

Referring to FIG. 1, the reference numeral 1 represents a transportation delivery planning system as a whole according to this embodiment. The transportation delivery planning system 1 includes a transportation delivery instruction management system 2, a service trip management system 3, and a sorting control system 4, as well as a transportation delivery planning apparatus 6 connected to these systems via a network 5.

The transportation delivery instruction management system 2 is a computer system that has a function creating, storing, and managing a transportation delivery instruction each time it receives a request for transportation and delivery of packages from a customer. The term “transportation delivery instruction” herein used is a transportation delivery instruction regarding a package(s) including a departure place (departure base), a possible departure time of day, an arrival place (arrival base), an arrival due time of day, a volume weight, an actual weight, and the number of package units of the package(s) requested by the customer for transportation and delivery.

Moreover, the service trip management system 3 is a computer system that has a function managing, as service trip information, a service plan for each service trip created in advance (plan of departing from which base at what time and arriving at which base at what time) and information about the relevant service trip itself such as a load capacity and a vehicle type of the service trip.

Furthermore, the sorting control system 4 is a computer system that has a function controlling sorting equipment such as sorters and shooters installed at each base respectively. The sorting control system 4 controls the sorting equipment at each base according to the transportation delivery plan devised by the transportation delivery planning apparatus 6 as described later.

The transportation delivery planning apparatus 6 is a computer device that has a function devising a transportation delivery plan for each target package to be transported and delivered, based on the transportation delivery instruction created and managed by the transportation delivery instruction management system 2 and the service trip information managed by the service trip management system 3. Incidentally, the expression “devising a transportation delivery plan” hereinafter used includes creating an assignment proposal for assigning each transportation delivery instruction to a service trip (to be precise, assigning the service trip for loading the target package to each transportation delivery instruction) and devising a sorting task plan of packages at each relay base (hereinafter referred to as a “sorting plan”).

This transportation delivery planning apparatus 6 is configured from a general-purpose personal computer or a server apparatus which is equipped with a CPU (Central Processing Unit) 10, a memory 11, a storage apparatus 12, an input device 13, a display device 14, and a communication device 15.

The CPU 10 is a processor that controls the operation of the entire transportation delivery planning apparatus 6. Moreover, the memory 11 is configured from a volatile semiconductor memory such as an SRAM (Static Random Access Memory) or a DRAM (Dynamic Random Access Memory) and is used as a working memory of the CPU 10.

The storage apparatus 12 is configured from a large-capacity nonvolatile storage apparatus such as a hard disk drive or SSD (Solid State Drive) and is used to retain various programs and information that need to be stored for a long period of time. The programs stored in the storage apparatus 12 are read from the storage apparatus 12 to the memory 11 when starting the transportation delivery planning apparatus 6 or whenever necessary; and the CPU 10 executes the programs read from the memory 11, thereby executing various processes as the entire transportation delivery planning apparatus 6 as described later.

The input device 13 is configured from devices such as a keyboard and a mouse and is used by a user to input necessary commands and information to the transportation delivery planning apparatus 6. Moreover, the display device 14 is configured from a liquid crystal display device, an organic EL (electro-luminescence) display device, or the like, and is used to display necessary information.

Furthermore, the communication device 15 is configured from, for example, an NIC (Network Interface Card) and performs protocol control during communication with the transportation delivery instruction management system 2, the service trip management system 3, and the sorting control system 4 via the network 5.

### (2) Transportation Delivery Planning Function

Next, a transportation delivery planning function mounted in the transportation delivery planning apparatus 6 according to this embodiment will be described. This transportation delivery planning function is a function devising a transportation delivery plan in which each transportation delivery instruction is assigned to a service trip, evaluating the transportation delivery plan in consideration of a package sorting ability at each relay base on a route from a departure place to an arrival place of each package, and modifying the transportation delivery plan as necessary to ensure that all packages at the relay base will be ready in time for connecting service trips based on the evaluation result.

Practically, the transportation delivery planning apparatus 6 firstly devises an assignment proposal to assign each transportation delivery instruction to a service trip by selecting, as a priority index, an index designated by the user in advance from several indices prepared in advance such as the “Lowest Cost” for minimizing transportation and delivery cost, the “Earliest Delivery Date and Time” for making a delivery date and time of each package the earliest, the “Smallest Number of Transshipments” for minimizing the number of transshipments of packages at a relay base, and by using an optimization method such as a local search method or a greedy algorithm using the priority index as an objective variable.

Then, the transportation delivery planning apparatus 6 devises a sorting plan for each package at each relay base based on the devised assignment proposal. Moreover, if there is any package(s) (transportation delivery instruction(s)) regarding which the sorting task cannot be completed in time before a departure of the relevant service trip to a connecting destination (hereinafter referred to as a “connecting service trip” as appropriate) according to the sorting plan created at each relay base, the transportation delivery planning apparatus 6 modifies the sorting plan or modifies the assignment proposal to the service trip of each transportation delivery instruction.

Furthermore, if the transportation delivery plan is modified as described above, the transportation delivery planning apparatus 6 devises the sorting plan for each relay base and calculates the sorting task time again, and repeats modifying the transportation delivery plan, devising the sorting plan at each relay base, and calculating the sorting task time until there are no more packages (transportation delivery instructions) that will not be ready in time before the departure. Then, the transportation delivery planning apparatus 6 displays the transportation delivery plan finally obtained by repeating the above-described processing on the display device 14 (FIG. 1).

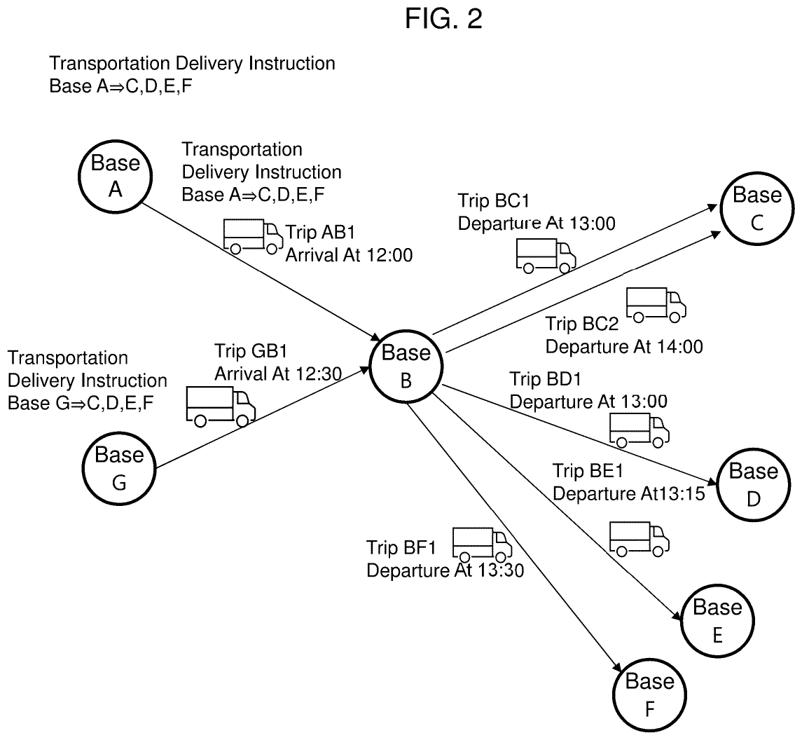

The details of such transportation delivery planning function will be described below. Incidentally, an explanation will be provided by assuming, as illustrated in FIG. 2 as appropriate, that there are “Base A” to “Base G” as bases, packages are transported from “Base A” to “Base C” to “Base F” by using “Base B” as a relay base, and packages are also transported from “Base G” to the bases “Base C” to “Base F” by using “Base B” as a relay base. However, it may be also assumed that there are direct service trips between the respective bases “Base A” to “Base G” mutually, there are service trips in the opposite direction of the arrows connecting the bases in FIG. 2, or furthermore there is a relay base other than “Base B.”

As a means of implementing the transportation delivery planning function according to this embodiment as described above, as illustrated in FIG. 1, the storage apparatus 12 for the transportation delivery planning apparatus 6 of this embodiment stores a service trip information table 20, a fare table 21, a base information table 22, a base sorting ability information table 23, a transportation delivery instruction information table 24, an assignment information table 25, a priority index information table 26, a relay information table 27, and a sorting plan information table 28, and the memory 11 for the transportation delivery planning apparatus 6 stores an assignment proposal creation unit 30, a sorting planning unit 31, and an evaluation determination unit 32.

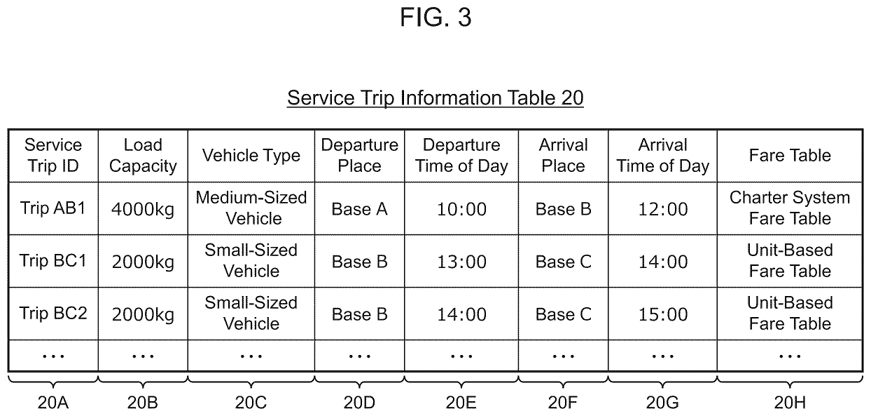

The service trip information table 20 is a table used to store and retain service trip information of each service trip obtained by the transportation delivery planning apparatus 6 from the service trip management system 3, and as illustrated in FIG. 3, it is configured by including a service trip ID column 20A, a load capacity column 20B, a vehicle type column 20C, a departure place column 20D, a departure time-of-day column 20E, an arrival place column 20F, an arrival time-of-day column 20G, and a fare table column 20H. In the service trip information table 20, one record (row) corresponds to the service trip information of one service trip.

Then, the service trip ID column 20A stores a unique identifier of the relevant service trip assigned to that service trip (service trip ID). Moreover, the load capacity column 20B stores a load capacity of the service trip; and the vehicle type column 20C stores the vehicle type of the service trip. The vehicle types include “large-sized vehicle,” “medium-sized vehicle,” and “small-sized vehicle.”

Furthermore, the departure place column 20D stores a departure base of the relevant service trip; and the departure time-of-day column 20E stores a scheduled time of day when the service trip will depart from the departure base. Moreover, the arrival place column 20F stores an arrival base of the relevant service trip; and the arrival time-of-day column 20G stores a scheduled time of day when the service trip will arrive at the arrival base. Furthermore, the fare table column 20H stores a fare table applied to the service trip.

Therefore, in the example illustrated in FIG. 3, it is shown that, for example, “Trip AB1” is a service trip for which a “medium-sized vehicle” with the load capacity of “4000 kg” will depart from “Base A” at “10:00” and will arrive at “Base B” at “12:00” and a “Charter System Fare Table” is applied as the fare table.

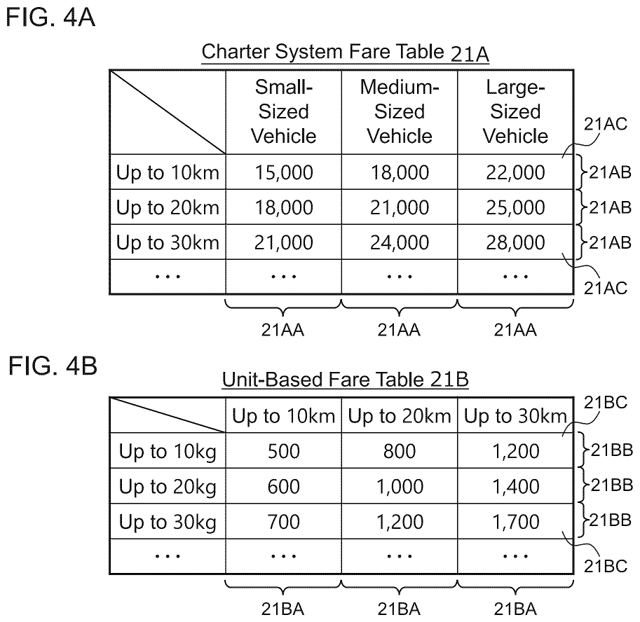

The fare table 21 is configured by including at least a charter system fare table 21A illustrated in FIG. 4A and a unit-based fare table 21B illustrated in FIG. 4B.

The charter system fare table 21A is a fare table for transporting and delivering packages in a charter system and is configured, as illustrated in FIG. 4A, by including columns 21AA provided corresponding to respective vehicle types (“small-sized vehicle,” “medium-sized vehicle,” and “large-sized vehicle”) and rows 21AB provided corresponding to respective service trip distances in units of 10 km (up to 10 km, up to 20 km, up to 30 km, and so on).

Then, each cell 21AC where a column 21AA and a row 21AB intersect stores a fare for using a vehicle of the vehicle type corresponding to the column 21AA to which the relevant cell 21AC belongs for transporting and delivering a package for the service trip distance corresponding to the row 21AB to which the relevant cell 21AC belongs.

Therefore, in the example of FIG. 4A, it is shown that, for example, the fare for using a “small-sized vehicle” is “15,000” yen for transportation and delivery of “(0) to 10 km,” “18,000” yen for transportation and delivery of “(10) to 20 km,” and “21,000” yen for transportation and delivery of “(20) to 30 km.”

Moreover, the unit-based fare table 21B is a fare table for transporting and delivering packages in units of the number of the packages and is configured, as illustrated in FIG. 4B, by including columns 21BA provided corresponding to the respective service trip distances in units of 10 km (up to 10 km, up to 20 km, up to 30 km, and so on) and rows 21BB provided corresponding to respective weights in units of 10 kg (up to 10 kg, up to 20 kg, up to 30 kg, and so on).

Then, each cell 21BC where a column 21BA and a row 21BB intersect stores a fare for transporting and delivering a package of the weight corresponding to the row 21BB to which the relevant cell 21BC belongs for the distance of the column 21BA to which the relevant cell 21BC belongs.

Therefore, in the example of FIG. 4B, it is shown that, for example, the fare for transporting and delivering a package of “(0) to 10 kg” is “500” yen for transportation and delivery of “(0) to 10 km,” “800” yen for transportation and delivery of “(10) to 20 km,” and “1,200” yen for transportation and delivery of “(20) to 30 km.”

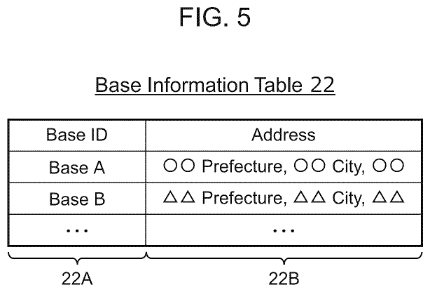

The base information table 22: is a table in which the addresses of respective bases existing in an area managed by the transportation delivery planning apparatus 6 are registered respectively; and is created in advance and given to the transportation delivery planning apparatus 6. The base information table 22 is configured, as illustrated in FIG. 5, by including a base ID column 22A and an address column 22B. In the base information table 22, one record (row) corresponds to one base existing in the area managed by the transportation delivery planning apparatus 6.

Then, the base ID column 22A stores a unique identifier of the relevant base, which is assigned to that base (Base ID); and the address column 22B stores the address of that base. Therefore, in the example of FIG. 5, it is shown that the address of “Base A” is “◯◯ Prefecture ◯◯ City ◯◯.”

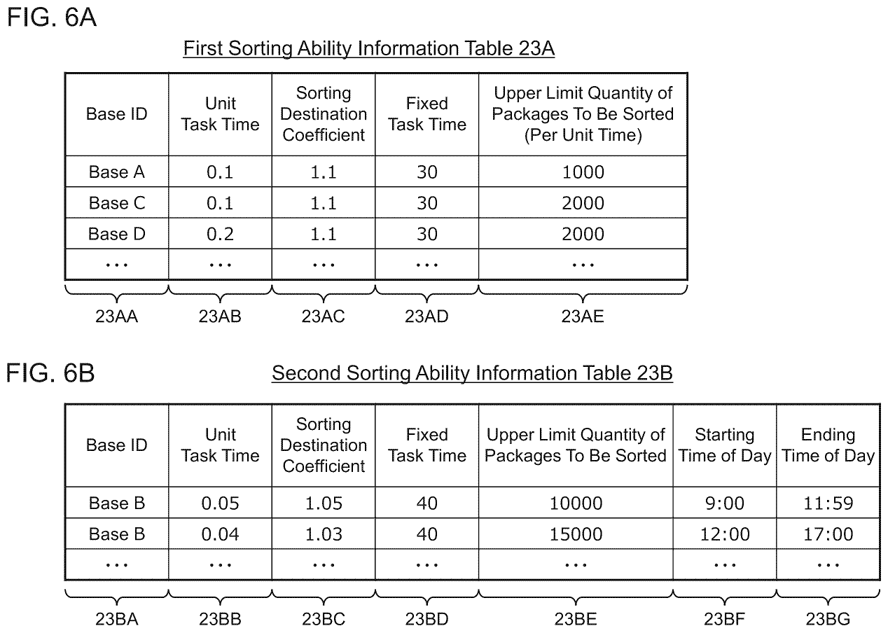

The base sorting ability information table 23 is a table used to manage the ability to sort packages at each base, and is composed of a first base sorting ability information table 23A illustrated in FIG. 6A and a second base sorting ability information table 23B illustrated in FIG. 6B. Incidentally, if the sorting task time depends on the quantity of packages below, the sorting task time is calculated by the following Expression 1.

[Expression 1]

Sorting Task Time=Unit Task Time×Quantity of Packages To Be Sorted+Fixed Time (1)

If the sorting task time depends on the quantity of packages and the number of destinations, the sorting task time is calculated by the following Expression 2.

$$\begin{matrix}[ Expression 2 ] & \\ Sorting Task Time = Unit Task Time \times Quantity of Packages to Be {Sorted}^{The Number of Destinations - 1} + Fixed Time & ( 2 )\end{matrix}$$

If the sorting task time depends on the quantity of packages, the number of destinations, and the upper limit quantity of packages to be sorted by the equipment such as sorters and shooters, the sorting task time is calculated by the following Expression 3.

$$\begin{matrix}[ Expression 3 ] & \\ Sorting Task Time = Unit Task Time \times Quantity of Packages to Be Sorted \times ( 1 + The Number of Destinations / Upper Limit Quantity of Packages To Be Sorted ) + Fixed Time & ( 3 )\end{matrix}$$

Incidentally, regarding these expressions, different expressions may be used depending on the sorting task method and/or the task environment.

The first base information table is a table for storing the sorting ability of each base where the sorting ability does not change depending on a time slot and it is configured, as illustrated in FIG. 6A, by including a base ID column 23AA, a unit task time column 23AB, a sorting destination coefficient column 23AC, a fixed task time column 23AD, and an upper limit quantity-of-packages-to-be-sorted column 23AE. In the first base sorting ability information table 23A, one record (row) corresponds to one base whose sorting ability does not change depending on time slots.

Then, the base ID column 23AA stores a base ID of the relevant base, the unit task time column 23AB stores unit task time of that base, and the sorting destination coefficient column 23AC stores a sorting destination coefficient of the base.

Moreover, the fixed task time column 23AD stores fixed task time at the relevant base. Incidentally, the fixed task time refers to fixed time that always occurs, for example, in preparation for performing the sorting task. Furthermore, the upper limit quantity-of-packages-to-be-sorted column 23AE stores the upper limit quantity of packages that can be sorted per unit time (upper limit quantity of packages to be sorted).

Therefore, in the example of FIG. 6A, it is shown that, for example, regarding “Base A,” the unit task time is “0.1,” the sorting destination coefficient is “1.1,” the fixed task time is “30,” and the upper limit quantity of packages to be sorted is “1000.”

Moreover, the second base sorting ability information table 23B is a table for storing the sorting ability of each base per time slot when the sorting ability of the base changes depending on time slots; and it is configured, as illustrated in FIG. 6B, by including a base ID column 23BA, a unit task time column 23BB, a sorting destination coefficient column 23BC, a fixed task time column 23BD, an upper limit quantity-of-packages-to-be-sorted column 23BE, a starting time-of-day column 23BF, and an ending time-of-day column 23BG.

In the second base sorting ability information table 23B, one record (row) corresponds to one time slot at one base whose sorting ability changes depending on time slots, and one record for each time slot in which the same sorting ability can be demonstrated during business hours is provided for each base.

Then, the base ID column 23BA, the unit task time column 23BB, the sorting destination coefficient column 23BC, the fixed task time column 23BD, and the upper limit quantity-of-packages-to-be-sorted column 23BE store information similar to that in the corresponding columns of the base ID column 23AA, the unit task time column 23AB, the sorting destination coefficient column 23AC, the fixed task time column 23AD, and upper limit quantity-of-packages-to-be-sorted column 23AE of the first base sorting ability information table 23A, respectively. Moreover, the starting time-of-day column 23BF stores the starting time of day of the time slot in which the corresponding sorting ability is maintained; and the ending time-of-day column 23BG stores the ending time of day of that time slot.

Therefore, in the example of FIG. 6B, it is shown that, for example, regarding “Base B,” during the time slot from “9:00” to “11:59,” the unit task time is “0.05,” the sorting destination coefficient is “1.05,” the fixed task time is “40,” and the upper limit quantity of packages to be sorted is “10,000,” while during the time slot from “12:00” to “17:00,” the unit task time is “0.04,” the sorting destination coefficient is “1.03,” the fixed task time is “40,” and the upper limit quantity of packages is “15000.”

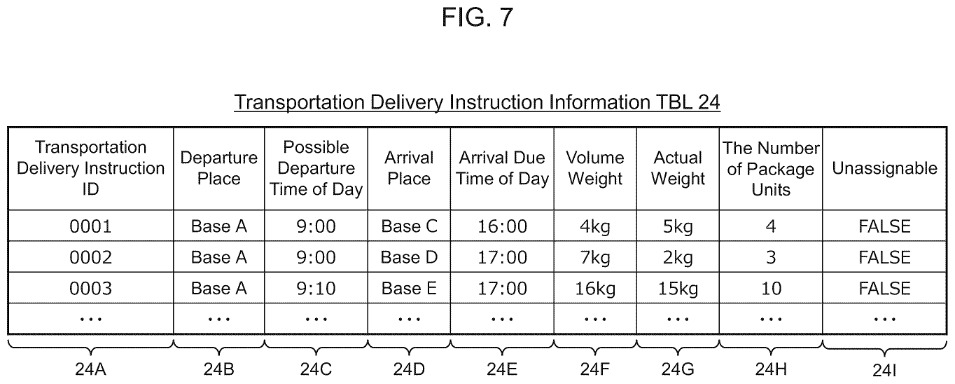

The transportation delivery instruction information table 24 is a table for storing information of each transportation delivery instruction obtained from the transportation delivery instruction management system 2 (transportation delivery instruction information); and it is configured, as illustrated in FIG. 7, by including a transportation delivery instruction ID column 24A, a departure place column 24B, a possible departure time-of-day column 24C, an arrival place column 24D, an arrival due time-of-day column 24E, a volume weight column 24F, an actual weight column 24G, a number-of-package-units column 24H, and an unassignable column 24I. In the transportation delivery instruction information table 24, one record (row) corresponds to one piece of transportation delivery instruction information obtained from the transportation delivery instruction management system 2 (transportation delivery instruction information).

Then, the transportation delivery instruction ID column 24A stores a unique identifier of the relevant transportation delivery instruction, which is assigned to that transportation delivery instruction in the transportation delivery instruction information table 24 (transportation delivery instruction ID). Moreover, the departure place column 24B stores the base ID of a departure base of the relevant target package of the transportation delivery instruction; and the possible departure time-of-day column 24C stores the time of day when that package can depart from the departure base.

Moreover, the arrival place column 24D stores the base ID of an arrival base of the relevant package; and the arrival due time-of-day column 24E stores a due time of day by when the package must arrive at the arrival base. Furthermore, the volume weight column 24F stores the volume weight per unit of the package; and the actual weight column 24G stores the actual weight per unit of the package.

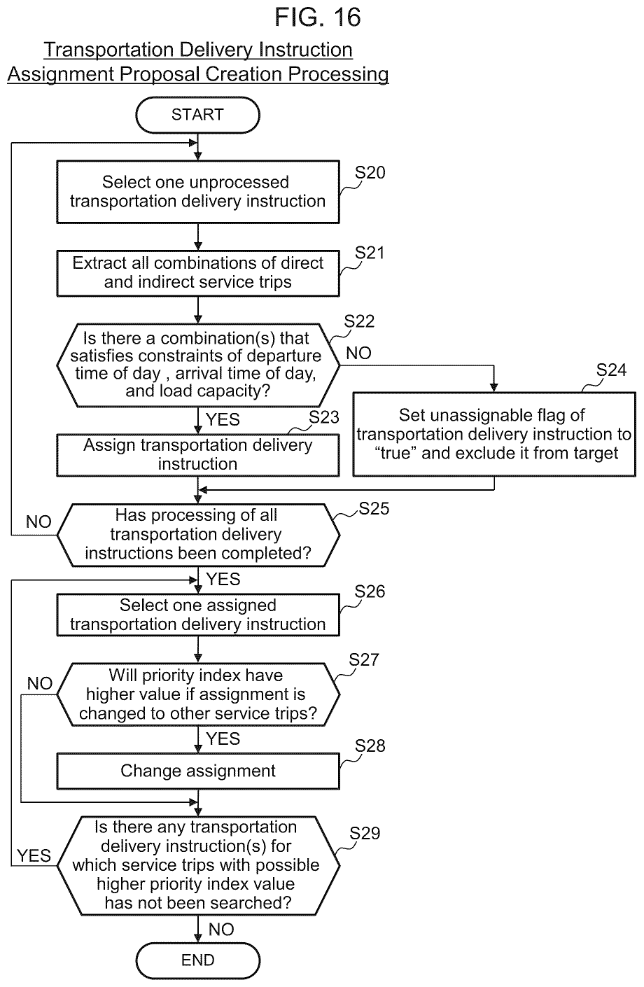

Furthermore, the number-of-package-units column 24H stores the number of package units of the package; and the unassignable column 24I stores a flag (hereinafter referred to as an “unassignable flag”) indicating whether or not the relevant transportation delivery instruction was successfully assigned to one of service trips (whether or not the target package of the relevant transportation delivery instruction was successfully assigned, as a target to be transported and delivered, to one of the service trips) by the transportation delivery instruction assignment proposal creation processing described later with reference to FIG. 16. Then, the unassignable flag is set to “FALSE” if the transportation delivery instruction was successfully assigned to one of the service trips; and it is set to “TRUE” if the transportation delivery instruction failed to be assigned to one of the service trips.

Therefore, in the example of FIG. 7, it is shown that the transportation delivery instruction to which the transportation delivery instruction ID “0001” is assigned is a transportation delivery instruction for transporting and delivering a package of “4” package units with the volume weight of “4 kg” and the actual weight of “5 kg,” indicating that the package can depart from the departure base “Base A” at “9:00” and is required to arrive at the arrival base “Base C” by “16:00” and the package was successfully assigned to one of the service trips (the unassignable flag is “FALSE”).

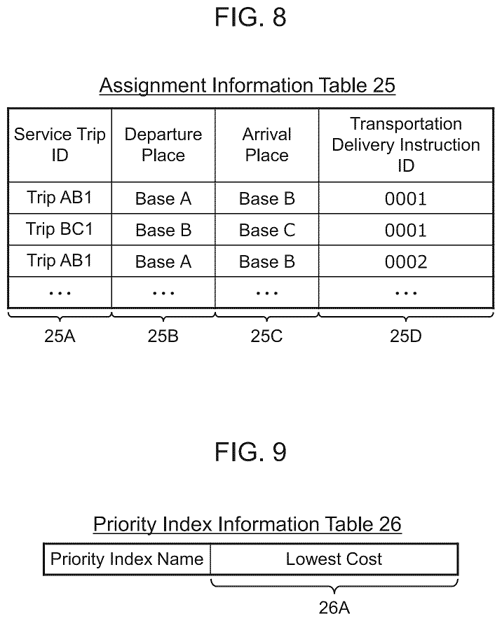

Moreover, the assignment information table 25 is a table used to manage the correspondence relationship between each service trip and a transportation delivery instruction assigned to that service trip and it is configured, as illustrated in FIG. 8, by including a service trip ID column 25A, a departure place column 25B, an arrival place column 25C, and a transportation delivery instruction ID column 25D. In the assignment information table 25, one record (row) corresponds to one of combinations of a service trip, to which one of the transportation delivery instructions is assigned, and a transportation delivery instruction assigned to that service trip.

Then, the service trip ID column 25A stores a service trip ID of the relevant service trip. Moreover, the departure place column 25B stores the base ID of a departure base of that service trip; and the arrival place column 25C stores the base ID of an arrival base of that service trip. Furthermore, the transportation delivery instruction ID column 25D stores a transportation delivery instruction ID of the relevant transportation delivery instruction assigned to that service trip.

Therefore, in the example illustrated in FIG. 8, it is shown that, for example, “Trip AB1” is a service trip for which the departure base is “Base A,” the arrival base is “Base B,” and at least a transportation delivery instruction with the transportation delivery instruction ID “0001” is assigned to that service trip.

The priority index information table 26 is a table for managing an index selected by the user as a priority index from among a plurality of indices prepared in advance. In this embodiment, three indices are provided as such priority index/indices: the “Lowest Cost” for which the cost of transportation and delivery is the lowest; the “Earliest Delivery Date and Time” for which the average delivery date and time of each package to be transported and delivered is the earliest; and the “Smallest Number of Transshipments” for which the number of transshipments of packages at a relay base is the smallest. Then, the transportation delivery planning apparatus 6 devises a transportation delivery plan to satisfy the content of the index selected by the user as the priority index from the three indices.

The priority index information table 26 is configured, as illustrated in FIG. 9, by including a priority index column 26A. Then, the priority index column 26A stores the index name of an index selected by the user as the priority index in advance. Therefore, in the example of FIG. 9, it is shown that the index “Lowest Cost” was selected by the user as the priority index from the three indices in advance.

The relay information table 27 is a table created in the process of devising a transportation delivery plan according to transportation delivery planning processing described later with reference to FIG. 16 and it is used to manage various kinds of information such as the arrival time of day and the departure time of day of a target package at a relay base regarding each transportation delivery instruction for the target package which goes through one of the relay bases.

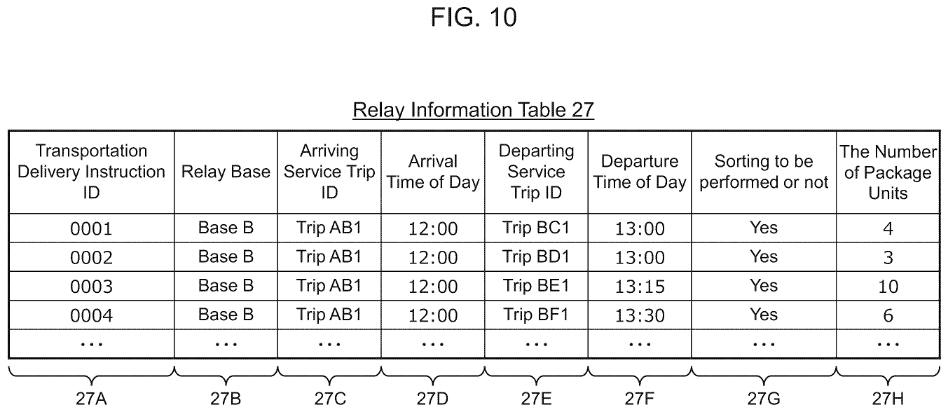

The relay information table 27 is configured, as illustrated in FIG. 10, by including a transportation delivery instruction ID column 27A, a relay base column 27B, an arriving service trip ID column 27C, an arrival time-of-day column 27D, a departing service trip ID column 27E, a departure time-of-day column 27F, a sorting-to-be-performed-or-not column 27G, and a number-of-package-units column 27H. In the relay information table 27, one record corresponds to information about one transportation delivery instruction at one relay base.

Then, the transportation delivery instruction ID column 27A stores a transportation delivery instruction ID of the relevant transportation delivery instruction; and the relay base column 27B stores the base ID of a relay base through which a target package of the transportation delivery instruction passes. Moreover, the arriving service trip ID column 27C stores a service trip ID of a service trip for transporting and delivering that package to the relay base; and the arrival time-of-day column 27D stores a scheduled time of day when the service trip will arrive at the relay base.

The departing service trip ID column 27E stores the service trip ID of a service trip for which the package will be relayed (sorted or transshipped) at the relay base; and the departure time-of-day column 27F stores a scheduled time of day when the service trip will depart from the relay base.

Moreover, the sorting-to-be-performed-or-not column 27G stores information indicating whether or not sorting of the relevant package will be performed at the relay base. Specifically, the sorting-to-be-performed-or-not column 27G stores: “Yes” if the package will be sorted at the relay base; and “No” if the package will not be sorted at the relay base (in the case where only the transshipment will be performed). Furthermore, the number-of-package-units column 27H stores the number of package units of the relevant package.

Therefore, in the example of FIG. 10, it is shown that, for example, the target package of the transportation delivery instruction “0001” consists of “4” package units and is scheduled to arrive at “Base B” at “12:00” on “Trip AB1” and then depart from “Base B” at “13:00” on “Trip BC1.” It is also shown that this package will be sorted at “Base B” (“Yes”).

The sorting plan information table 28 is also a table created in the process of devising the transportation delivery plan according to the transportation delivery planning processing described later with reference to FIG. 16. This sorting plan information table 28 is used to store a sorting plan for each relay base, which is created based on the information stored in the relay information table 27.

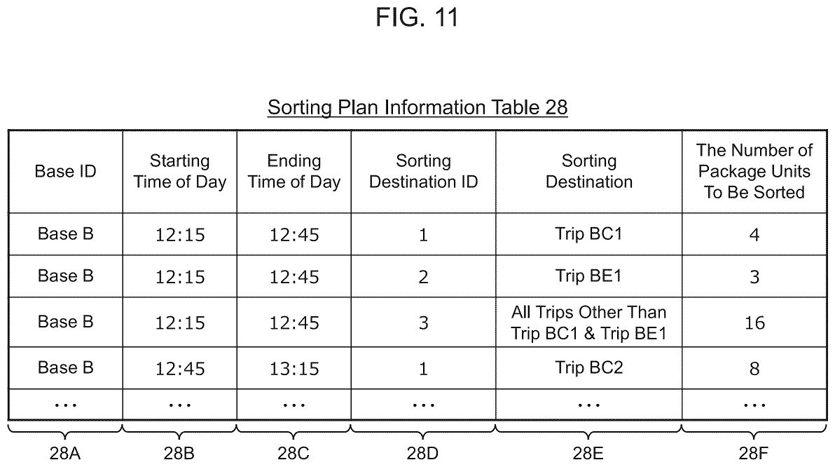

This sorting plan information table 28 is configured, as illustrated in FIG. 11, by including a base ID column 28A, a starting time-of-day column 28B, an ending time-of-day column 28C, a sorting destination ID column 28D, a sorting destination column 28E, and a number-of-package-units column 28F. In the sorting plan information table 28, one record corresponds to one sorting destination of one sorting task at the relevant relay base.

Then, the base ID column 28A stores the base ID of a relay base where the relevant sorting task is to be performed. Moreover, the starting time-of-day column 28B stores the starting time of day of the sorting task; and the ending time-of-day column 28C stores the ending time of day of the sorting task.

Moreover, the sorting destination ID column 28D stores an identifier assigned to the relevant sorting destination corresponding to the sorting task (sorting destination ID); and the sorting destination column 28E stores a service trip ID of a service trip of the sorting destination. Furthermore, the number-of-package-units column 28F stores the number of package units to be sorted to the sorting destination by the sorting task.

Therefore, in the example of FIG. 11, it is shown that at “Base B” during a time slot from “12:15” to “13:45,” for example, a sorting plan is devised to sort “4” package units to the service trip “Trip BC1” which is a sorting destination with the sorting destination ID “1,” to sort “3” package units to the service trip “Trip BE1” which is a sorting destination of the sorting destination ID “2,” and to sort “16” package units to a service trip indicated as “All Trips Other Than Trip BC1 and Trip BE1” which is a sorting destination with the sorting destination ID “3.”

On the other hand, the assignment proposal creation unit 30 is a program that has a function creating an assignment proposal for assigning each transportation delivery instruction registered in the transportation delivery instruction information table 24 (FIG. 7) to one of the service trips (i.e., devising a transportation delivery plan).

Practically, based on the information such as the departure place, the possible departure time of day, the arrival place, and the arrival due time of day of a target package to be transported and delivered which is designated in the transportation delivery instruction (see FIG. 7), the information such as the load capacity, the departure place, the departure time of day, the arrival place, and the arrival time of day of each service trip (see FIG. 3), and the task time at the relay base in a case where the package goes through the relay base, the assignment proposal creation unit 30 assigns each transportation delivery instruction stored in transportation delivery instruction information table 24 to any one of the service trips by using an arbitrary optimization method such as a local search method or a greedy algorithm. In this case, an operation is performed by using the priority index, which is stored in the priority index information table 26 (FIG. 9), as an objective variable for optimization. Then, the assignment proposal creation unit 30 registers the created assignment proposal (transportation delivery plan) in the assignment information table 25 (FIG. 8).

The sorting planning unit 31 is a program that has a function predicting the task time of the sorting task at each relay base when the transportation and delivery of packages is performed according to the assignment proposal created by the assignment proposal creation unit 30, and devising a sorting plan based on the predicted task time.

The evaluation determination unit 32 is a program that has a function judging whether or not there is any package(s) for which the sorting task will not be completed before the departure of the service trip to the connecting destination if the sorting task is performed according to the sorting plan of the sorting task at each relay base as planned by the sorting planning unit 31. If the evaluation determination unit 32 determines that the sorting plan of the sorting task at each relay base as planned by the sorting planning unit 31 is feasible, it displays the outline of the assignment proposal and the sorting plan created at that time on the display device 14 as a proposed transportation delivery plan (FIG. 1).

### (3) Configuration of Transportation Delivery Planning Instruction Screen

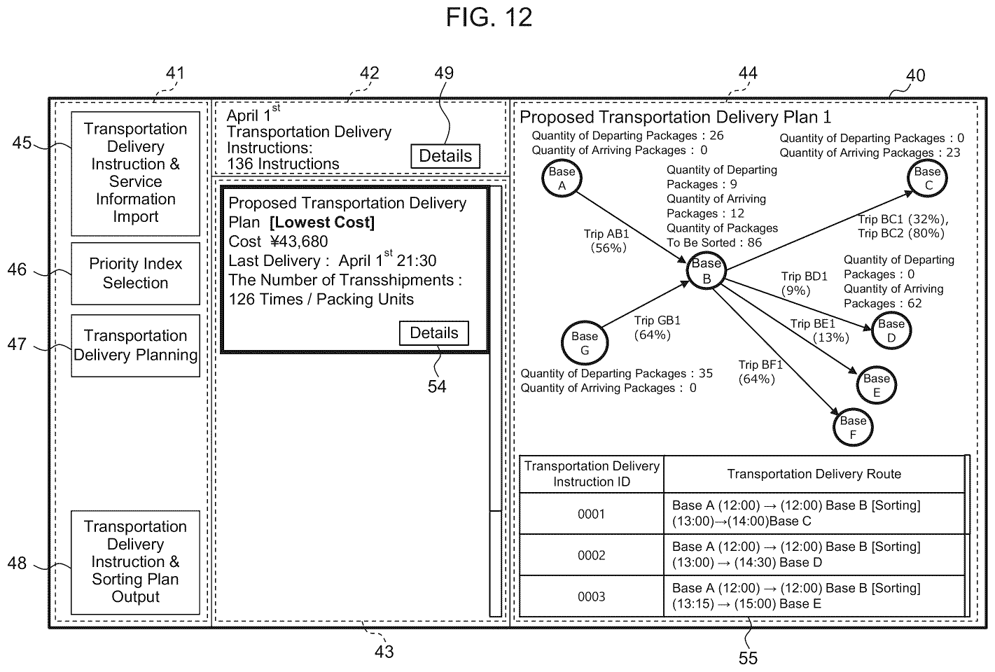

FIG. 12 illustrates a screen configuration example of a transportation delivery planning instruction screen 40 that can be displayed on the display device 14 by a specified operation using the input device 13 (FIG. 1) with respect to the transportation delivery planning function of this embodiment. This transportation delivery planning instruction screen 40 is configured by including a button display area 41, a transportation delivery instruction count display area 42, a proposed transportation delivery plan outline display area 43, and a proposed transportation delivery plan graph display area 44.

Then, on the transportation delivery planning instruction screen 40, the button display area 41 initially displays a transportation delivery instruction & service information import button 45, a priority index selection button 46, a transportation delivery planning button 47, and a transportation delivery task instruction & sorting plan output button 48, and nothing is displayed in the transportation delivery instruction count display area 42, the proposed transportation delivery plan outline display area 43, and the proposed transportation delivery plan graph display area 44.

Then, by clicking on the transportation delivery instruction & service information import button 45, the user can issue an instruction to the transportation delivery planning apparatus 6 to obtain the transportation delivery instruction and the service information of the service trip from the transportation delivery instruction management system 2 (FIG. 1) and the service trip management system 3 (FIG. 1). Then, the number of transportation delivery instructions for today obtained at that time is displayed in the transportation delivery instruction count display area 42. Incidentally, at that time, a details button 49 is also displayed in the transportation delivery instruction count display area 42 and the user can display the details of each transportation delivery instruction for today in a popup (which is not illustrated in the drawing) by clicking on the details button 49.

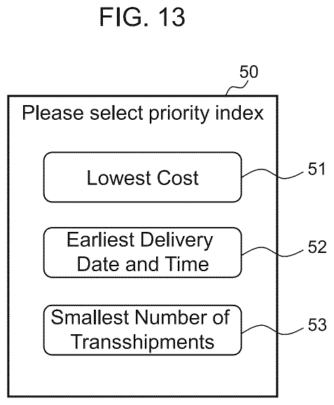

Moreover, on the transportation delivery planning instruction screen 40, by clicking on the priority index selection button 46, as illustrated in FIG. 13, the user can display a popup 50 provided with buttons 51, 52, and 53 respectively corresponding to the respective indices of the “Lowest Cost,” the “Earliest Delivery Date and Time,” and the “Smallest Number of Transshipments” which can be selected as the priority index (hereinafter referred to as “index buttons”).

Consequently, by clicking on one of the index buttons 51 to 53 corresponding to a desired index from among the index buttons 51 to 53 displayed in the popup 50, the user can designate the index as the priority index for the transportation delivery planning.

Furthermore, on the transportation delivery planning instruction screen 40, by clicking on the transportation delivery planning button 47, the user can give an instruction to the transportation delivery planning apparatus 6 to devise a proposed transportation delivery plan. Then, as a result, the outline of the devised proposed transportation delivery plan (including the selected priority index) is displayed in the proposed transportation delivery plan outline display area 43. Incidentally, at that time, a details button 54 is also displayed in the transportation delivery plan outline display area and the user can display the details of the proposed transportation delivery plan as a popup by clicking on the details button 54.

Moreover, if the transportation delivery planning button 47 is clicked, a more detailed outline of the devised proposed transportation delivery plan is displayed in a graph form in the proposed transportation delivery plan graph display area 44. Moreover, in the bottom part of the proposed transportation delivery plan graph display area 44, a transportation delivery route list 55 for each transportation delivery plan is also displayed in which sorting plans including transportation delivery routes of the respective packages corresponding to the respective transportation delivery instructions are displayed.

Furthermore, on the transportation delivery planning instruction screen 40, by clicking on the transportation delivery task instruction & sorting plan output button 48, a transportation delivery task instruction regarding the package by each service trip based on the transportation delivery plan devised by the transportation delivery planning apparatus 6 (assignment proposal of the transportation delivery instruction to the relevant service trip) can be transmitted to a driver of each service trip and the sorting plan devised by the transportation delivery planning apparatus 6 can be transmitted to the sorting control system 4. Consequently, the driver transports and delivers the packages assigned to them on the service trip driven by that driver according to the transmitted transportation delivery task instruction. Moreover, the sorting control system 4 controls the sorting equipment such as sorters and shooters at each relay base according to the transmitted sorting plan.

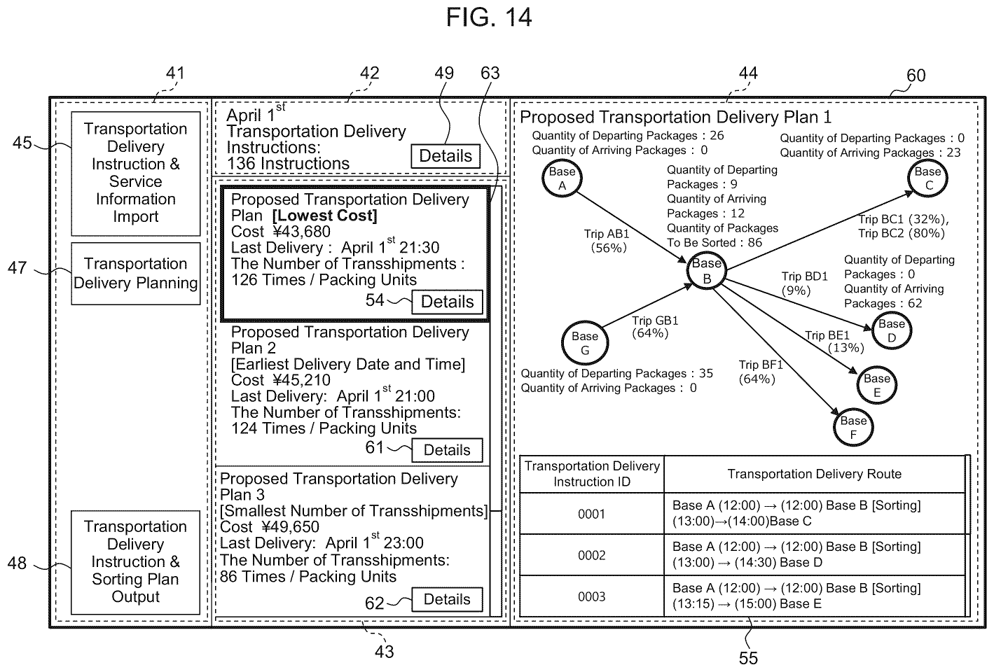

On the other hand, FIG. 14, in which parts corresponding to those in FIG. 12 are given the same reference numerals, illustrates a configuration example of a transportation delivery planning instruction screen 60 according to another embodiment. This transportation delivery planning instruction screen 60 basically has the same configuration as that of the transportation delivery planning instruction screen 40 described above with reference to FIG. 12. However, in this transportation delivery planning instruction screen 60, the button display area 41 displays only the transportation delivery instruction & service information import button 45, the transportation delivery planning button 47, and the transportation delivery task instruction & sorting plan output button 48, but does not display the priority index selection button 46 (FIG. 12).

Then, on the transportation delivery planning instruction screen 60, by clicking on the transportation delivery planning button 47, the user can give an instruction to the transportation delivery planning apparatus 6 to devise a proposed transportation delivery plan when each of the “Lowest Cost,” the “Earliest Delivery Date and Time,” and the “Smallest Number of Transshipments” is set as the priority index. Then, the outline of each proposed transportation delivery plan devised at that time with the “Lowest Cost,” the “Earliest Delivery Date and Time,” or the “Smallest Number of Transshipments” as the priority index is displayed in the proposed transportation delivery plan outline display area 43.

Moreover, in the proposed transportation delivery plan outline display area 43, the details buttons 54, 61, and 62 are also displayed corresponding to each proposed transportation delivery plan in which the “Lowest Cost,” the “Earliest Delivery Date and Time,” or the “Smallest Number of Transshipments” is set to the priority index; and, by clicking on the details buttons 54, 61, and 62, the user can display the details of each proposed transportation delivery plan which prioritizes the relevant priority index as a popup.

Furthermore, on the transportation delivery planning instruction screen 60, by clicking and selecting one desired outline from the outlines of the respective proposed transportation delivery plans with the “Lowest Cost,” the “Earliest Delivery Date and Time,” or the “Smallest Number of Transshipments” as the priority index displayed in the proposed transportation delivery plan outline display area 43, the more detailed outline of a proposed transportation delivery plan corresponding to the outline is displayed in the graph form in the proposed transportation delivery plan graph display area 44. Moreover, in the bottom part of the proposed transportation delivery plan graph display area 44, a transportation delivery route list 55 for each transportation delivery plan is also displayed in which transportation delivery routes of the respective packages corresponding to the respective transportation delivery instructions in the transportation delivery plan are displayed respectively.

Under this circumstance, a frame 63 which surrounds the outline of the proposed transportation delivery plan is displayed so that it can be understood that the outline of the proposed transportation delivery plan displayed in the proposed transportation delivery plan outline display area 43 selected as described above corresponds to the outline displayed in the graph form in the proposed transportation delivery plan graph display area 44 at that time.

### (4) Various Processing Regarding Transportation Delivery Planning Function

Next, various specific details performed in the transportation and delivery planning apparatus regarding the transportation delivery planning function of this embodiment will be described.

### (4-1) Transportation Delivery Planning Processing

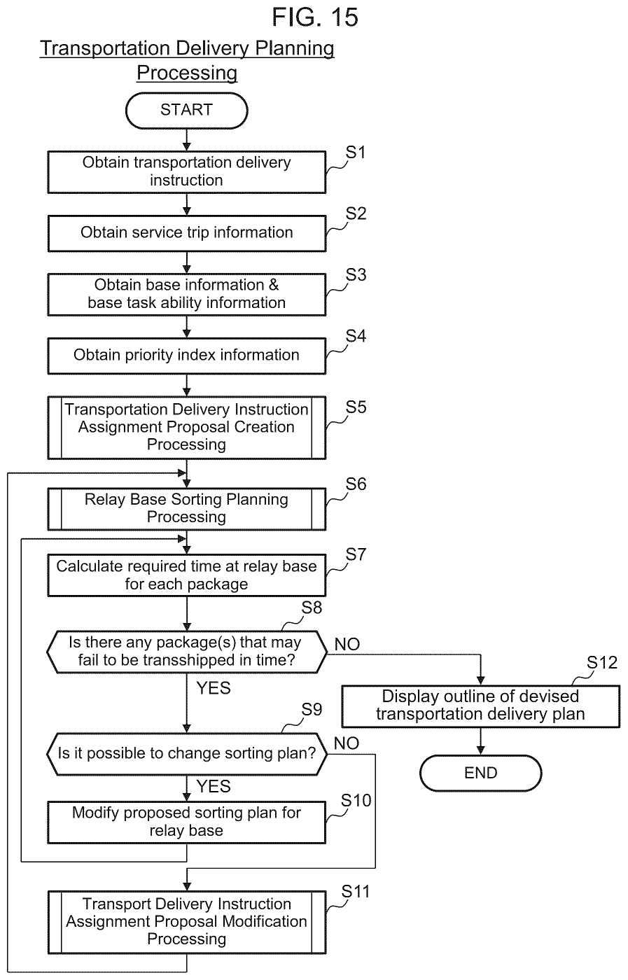

FIG. 15 illustrates a flow of a series of processing executed by the transportation delivery planning apparatus 6 when the transportation delivery planning button 47 of the transportation delivery planning instruction screens 40 and 60 described above with reference to FIG. 12 and FIG. 14 is clicked (hereinafter referred to as “transportation delivery planning processing”).

When the transportation delivery planning button 47 is clicked, the assignment proposal creation unit 30 (FIG. 1) firstly obtains transportation delivery instructions for today from the transportation delivery instruction management system 2 and stores the obtained information of each transportation delivery instruction in the transportation delivery instruction information table 24 (FIG. 7) (S1). Moreover, the assignment proposal creation unit 30 obtains the service trip information of each service trip from the service trip management system 3 (FIG. 1) and stores the obtained service trip information of each service trip in the service trip information table 20 (FIG. 3) (S2).

Subsequently, the assignment proposal creation unit 30 obtains the address of each base from the base information table 22 and obtains the sorting ability of each base from the base sorting ability information table 23 (FIG. 1) (S3). Furthermore, the assignment proposal creation unit 30 obtains the priority index designated by the user from the priority index information table 26 (FIG. 9) (S4).

Next, the assignment proposal creation unit 30 executes the transportation delivery instruction assignment processing for assigning each transportation delivery instruction registered in the transportation delivery instruction information table 24 to any one of the service trips while considering the priority index (S5), and then invokes the sorting planning unit 31. Moreover, when the sorting planning unit 31 is invoked by the assignment proposal creation unit 30, it executes the relay base sorting planning processing for devising a package sorting plan at each relay base (S6).

Subsequently, the assignment proposal creation unit 30 invokes the evaluation determination unit 32. Then, when the evaluation determination unit 32 is invoked by the assignment proposal creation unit 30, it calculates, regarding each package going through any one of the relay bases, the task time required to sort the packages at that relay base by using a calculation method corresponding to the package sorting ability at that relay base (in this embodiment, Expressions (1) to (3) described earlier) (S7).

Moreover, based on the calculated task time required for sorting each package, the evaluation determination unit 32 judges whether or not there is any package that will not be sorted in time before the departure time of day of a connecting service trip from the relay base (S8).

If an affirmative result is obtained in this judgment, the assignment proposal creation unit 30 judges whether or not it is possible to update the sorting plan at any one relay base (hereinafter referred to as a “target relay base”) where there is any package(s) that may fail to be transshipped in time (whether or not it is possible to devise a proposed sorting plan once again) (S9). This judgment may be made in various methods, for example, by judging whether or not it is possible to sort packages collectively which have arrived during a certain time frame which is set by setting divided time frames.

Then, if an affirmative result is obtained in this judgment, the assignment proposal creation unit 30 invokes the sorting planning unit 31. Moreover, when the sorting planning unit 31 is invoked by the assignment proposal creation unit 30, it modifies the sorting plan proposals respectively so that all packages may be transshipped in time for connecting service trips at the target relay base (S10). Then, when the sorting plan proposals are modified by the sorting planning unit 31, the processing in and after step S7 is executed again.

On the other hand, if a negative result is obtained in the judgment of step S9, the assignment proposal creation unit 30 executes the transportation delivery instruction assignment proposal modification processing for modifying the assignment proposal to the service trip of the necessary transportation delivery instruction so that all packages may be transshipped in time for connecting service trips at the target relay base (S11). Then, when the modification of the assignment proposal has been completed, the assignment proposal creation unit 30 returns to step S6. As a result, the processing of step S6 and its subsequent steps are executed again.

Then, if an affirmative result is obtained in step S8 because an assignment proposal in which all packages may be transshipped in time for connecting service trips at the relay base and a sorting plan proposal at each relay base are obtained, the evaluation determination unit 32 displays the outline of the assignment proposal and the sorting plan proposal at each relay base (transportation delivery plan) in the proposed transportation delivery plan outline display area 43 of the transportation delivery planning instruction screens 40 and 60 described above with reference to FIG. 12 and FIG. 14 as described above (S12), and then terminates this series of processing. Consequently, the transportation delivery planning processing is completed.

### (4-2) Transportation Delivery Instruction Assignment Proposal Creation Processing

FIG. 16 illustrates an example of specific processing content of the transportation delivery instruction assignment proposal creation processing executed by the assignment proposal creation unit 30 in step S5 of the transportation delivery planning processing described above with reference to FIG. 15. According to the processing sequence illustrated in FIG. 16, the assignment proposal creation unit 30 creates an assignment proposal in which each transportation delivery instruction registered in the transportation delivery instruction information table 24 is assigned to any one of the service trips in consideration of the priority index.

Practically, when the process proceeds to step S5 of the transportation delivery planning processing, the assignment proposal creation unit 30 starts the transportation delivery instruction assignment proposal creation processing illustrated in FIG. 16, and firstly selects one of the transportation delivery instructions, for which step 21 and its subsequent steps have not been processed, from among the transportation delivery instructions registered in the transportation delivery instruction information table 24 (FIG. 7) (S20).

Subsequently, by referring to the service trip information table 20 (FIG. 3), the assignment proposal creation unit 30 extracts all combinations of direct service trips that directly go from the departure place (departure base) to the arrival place (arrival base) of the transportation delivery instruction selected in step S20 (hereinafter referred to as a “selected transportation delivery instruction”) (hereinafter referred to a “direct service trip” as appropriate) or indirect service trips that go through any one of the relay bases (hereinafter referred to as an “indirect service trip” as appropriate) (S21).

For example, the assignment proposal creation unit 30 extracts, as a direct service trip, a service trip whose record has the departure place of the selected transportation delivery instruction stored in the departure place column 20D and has the arrival place of the transportation delivery instruction stored in the arrival place column 20F, from among the service trips registered in the service trip information table 20.

Moreover, in the service trip information table 20, the assignment proposal creation unit 30 firstly repeats the task of extracting service trips whose departure places are the departure place in the selected transportation delivery instruction, extracting service trips whose departure places are the arrival place(s) of the above-extracted service trips, and further extracting service trips whose departure places are the arrival place(s) of the above-extracted service trips, and finally extracts, as combinations of indirect service trips, all combinations of the service trips whose arrival places are the arrival place in the selected transportation delivery instruction.

Next, the assignment proposal creation unit 30 judges whether or not there is any combination(s) of direct or indirect service trips that can transport and deliver the packages of the possible departure time of day, the arrival due time of day, the volume weight, the actual weight, and the number of package units designated in the selected transportation delivery instruction among the combinations of the direct or indirect service trips extracted in step S21 (S22).

Specifically, the assignment proposal creation unit 30 judges whether or not, among the combinations of the direct or indirect service trips extracted in step S21, there is any combination(s) of direct or indirect service trips that will depart from the departure place at or after the possible departure time of day designated in the selected transportation delivery instruction, will arrive at the arrival place by the arrival due time of day designated in the selected transportation delivery instruction, and can transport and deliver packages regarding which the service trip(s) (the relevant direct service trip in the case of a direct service trip or all indirect service trips in the case of combinations of indirect service trips) can transport and deliver packages of the volume weight, the actual weight, and the number of package units designated in the selected transportation delivery instruction.

Then, if an affirmative result is obtained in this judgment, the assignment proposal creation unit 30 selects one of such combinations of direct or indirect service trips, assigns the selected transportation delivery instruction to the selected combination of direct or indirect service trips, and stores the assignment result in the assignment information table 25 (FIG. 8). Moreover, the assignment proposal creation unit 30 sets “FALSE” as the unassignable flag stored in the unassignable column 24I (FIG. 7) of the record corresponding to the selected transportation delivery instruction in the transportation delivery instruction information table 24 (FIG. 7) (S23).

On the other hand, if a negative result is obtained in the judgment of step S22, the assignment proposal creation unit 30 sets “TRUE” as the unassignable flag stored in the unassignable column 24I of the record corresponding to the selected transportation delivery instruction in the transportation delivery instruction information table 24, and then excludes the selected transportation delivery instruction from the target of the processing (S24). However, in order to prevent the occurrence of non-assignment of the transportation delivery instruction to the service trip, the selected transportation delivery instruction may be assigned to one of the service trips by some method instead of excluding it from the processing target.

Subsequently, the assignment proposal creation unit 30 judges whether or not the processing of steps S21 to S24 has been completed for all the transportation delivery instructions registered in the transportation delivery instruction information table 24 (S25).

If a negative result is obtained in this judgment, the assignment proposal creation unit 30 returns to step S20, and then repeats the processing of steps S20 to S25 while sequentially switching the transportation delivery instruction to be selected in step S20 to another transportation delivery instruction regarding which step S21 and its subsequent steps have not been processed.

Then, if an affirmative result is eventually obtained in step S25 by completing the execution of the processing in steps S21 to S25 for all the transportation delivery instructions registered in transportation delivery instruction information table 24, the assignment proposal creation unit 30 selects one transportation delivery instruction, which is a transportation delivery instruction to which a service trip has been assigned and for which step S27 and its subsequent steps have not been processed, from the transportation delivery instructions registered in the transportation delivery instruction information table 24 (S26).

Subsequently, the assignment proposal creation unit 30 judges whether or not the priority index will result in a better value by changing the assignment to other service trips regarding the transportation delivery instruction selected in step 26 (hereinafter referred to as a “selectively-assigned transportation delivery instruction”) (S27).

For example, if the priority index is “Cost To be Prioritized,” the assignment proposal creation unit 30: searches for a combination of direct or indirect service trips that satisfies the conditions of the possible departure time of day, the arrival due time of day, and the load capacity designated in the selectively-assigned transportation delivery instruction and has a lower fare than the combination of direct or indirect service trips to which the selectively-assigned transportation delivery instruction is currently assigned; and judges whether or not such a combination of direct or indirect service trips exists.

Moreover, if the priority index is the “Earliest Delivery Date and Time,” the assignment proposal creation unit 30: searches for a combination of direct or indirect service trips that satisfies the conditions of the possible departure time of day, the arrival due time of day, and the load capacity designated in the selectively-assigned transportation delivery instruction and can arrive at the arrival place earlier than the combination of direct or indirect service trips to which the selectively-assigned transportation delivery instruction is currently assigned; and judges whether or not such a combination of direct or indirect service trips exists.

Furthermore, if the priority index is the “Smallest Number of Transshipments,” the assignment proposal creation unit 30: searches for a combination of direct or indirect service trips that satisfies the conditions of the possible departure time of day, the arrival due time of day, and the load capacity designated in the selectively-assigned transportation delivery instruction and has a fewer number of transshipments than that of the combination of direct or indirect service trips to which the selectively-assigned transportation delivery instruction is currently assigned; and judges whether or not such a combination of direct or indirect service trips exists.

Then, if a negative result is obtained in this judgment, the assignment proposal creation unit 30 proceeds to step S29. Moreover, if an affirmative result is obtained in the judgment of step S27, the assignment proposal creation unit 30 updates the assignment information table 25 (FIG. 8) so that the assignment of a service trip to the selectively-assigned transportation delivery instruction will be changed to the combination of direct or indirect service trips detected by searching in step S27 (S28).

Subsequently, the assignment proposal creation unit 30 judges whether or not step S27 and its subsequent steps have been processed for all the transportation delivery instructions registered in the transportation delivery instruction information table 24 and assigned to the service trips (a combination of direct or indirect service trips) (S29).

If a negative result is obtained in this judgment, the assignment proposal creation unit 30 returns to step S26 and then repeats the processing of steps S26 to S29 while sequentially switching the transportation delivery instruction to be selected in step S26 to another transportation delivery instruction regarding which step S27 and its subsequent steps have not been processed and which is assigned to any one of the service trips (a combination of direct or indirect service trips).

Then, if an affirmative result is eventually obtained in step S29 by completing the execution of the processing of step S27 and its subsequent steps for all the transportation delivery instructions registered in the transportation delivery instruction information table 24 and assigned to service trips, the assignment proposal creation unit 30 completes this transportation delivery instruction assignment proposal creation processing and returns to the transportation delivery planning processing.

Incidentally, the transportation delivery instruction assignment proposal creation processing described above is an example of the case where a service trip is assigned to each transportation delivery instruction registered in the transportation delivery instruction information table 24 by using a so-called local search method, and the service trip may be assigned by using another approximate solution method for an optimization problem such as a greedy algorithm.

### (4-3) Relay Base Sorting Planning Processing

Next, an explanation will be provided about specific content of the relay base sorting planning processing executed by the sorting planning unit 31 in step S6 of the transportation delivery planning processing described above with reference to FIG. 15. Incidentally, since the content of the relay base sorting planning processing would vary depending on whether the quantity of packages to be sorted at the target relay base is limited or not, these processing sequences will be described separately.

### (4-3-1) First Relay Base Sorting Planning Processing

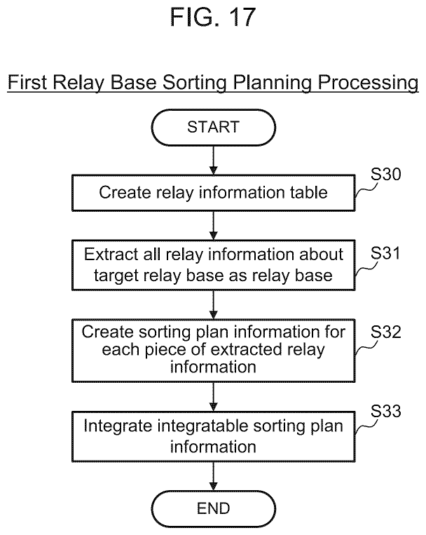

FIG. 17 illustrates an example of specific processing content of the relay base sorting planning processing executed by the sorting planning unit 31 for a relay base where the number of sorting destinations is not limited (hereinafter is referred to as “first relay base sorting planning processing”) in step S6 of the transportation delivery planning processing described earlier with reference to FIG. 15. The sorting planning unit 31 devises a sorting plan for the relay base to be then targeted according to the processing sequence illustrated in FIG. 17 (hereinafter referred to as a “target relay base”).

Practically, the sorting planning unit 31 firstly creates the relay information table 27 described earlier with reference to FIG. 10, based on the assignment information for each service trip stored in the assignment information table 25 (FIG. 8), the service trip information of each service trip stored in the service trip information table 20 (FIG. 3), and the transportation delivery instruction information of each transportation delivery instruction stored in the transportation delivery instruction information table 24 (S30).

Specifically, the sorting planning unit 31 extracts all records, in which a base ID of one of the relay bases is stored in the arrival place column 25C, from the respective records in the assignment information table 25, and obtains the transportation delivery instruction ID stored in the transportation delivery instruction ID column 25D, the base ID stored in the arrival place column 25C, and the service trip ID stored in the service trip ID column 25A regarding one of the extracted records (hereinafter referred to as a “first assignment information record”). Moreover, the sorting planning unit 31 secures an unused record in the relay information table 27 and stores the transportation delivery instruction ID, the base ID, and the service trip ID obtained from the first assignment information record of the assignment information table 25 as described above in the transportation delivery instruction ID column 27A, the relay base column 27B, and the arriving service trip ID column 27C of the secured unused record (hereinafter referred to as a “target record”).

Moreover, the sorting planning unit 31 extracts a record, in which the transportation delivery instruction ID obtained from the first assignment information record is stored in the transportation delivery instruction ID column 25D and the base ID obtained from the first assignment information record is stored in the departure place column 25B (hereinafter referred to as a “second assignment information record”), from among the records other than the first assignment information record in the assignment information table 25. Then, the sorting planning unit 31 stores the service trip ID, which is stored in the service trip ID column 25A of the extracted second assignment information record, in the departing service trip ID column 27E of the above-described target record of the relay information table 27.

Furthermore, the sorting planning unit 31 extracts the time of day at which the service trip whose service trip ID is stored in the arriving service trip ID column 27C of the above-described target record of the relay information table 27 arrives at the relay base with the base ID stored in the relay base column 27B of the target record, and the time of day at which the service trip whose service trip ID is stored in the departing service trip ID column 27E of the target record departs from the relevant relay base, from the service trip information table 20 (FIG. 3), and stores these times of day in the arrival time-of-day column 27D and the departure time-of-day column 27F of the target record, respectively.

Furthermore, the sorting planning unit 31 identifies a record in which the transportation delivery instruction ID stored in the transportation delivery instruction ID column 27A of the target record of the relay information table 27 is stored in the transportation delivery instruction ID column 24A, from the respective records of the transportation delivery instruction information table 24 (FIG. 7), obtains the number of package units stored in the number-of-package-units column 24H of the identified record, and stores it in the number-of-package-units column 27H of the target record of the relay information table 27.

Furthermore, the sorting planning unit 31 judges, regarding the current transportation delivery plan, whether or not the target package(s) of the transportation delivery instruction to which the transportation delivery instruction ID stored in the transportation delivery instruction ID column 27A of the target record is assigned is scheduled to be sorted at the target relay base; and the sorting planning unit 31 stores “Yes” if the sorting is scheduled; and it stores “No” if the sorting is not scheduled in the sorting-to-be-performed-or-not column 27G.

Then, the sorting planning unit 31 executes the above processing for all the records in which the base ID of any one of the relay bases is stored in the arrival place column 25C from among the respective records of the assignment information table 25. Consequently, the relay information table 27 is created.

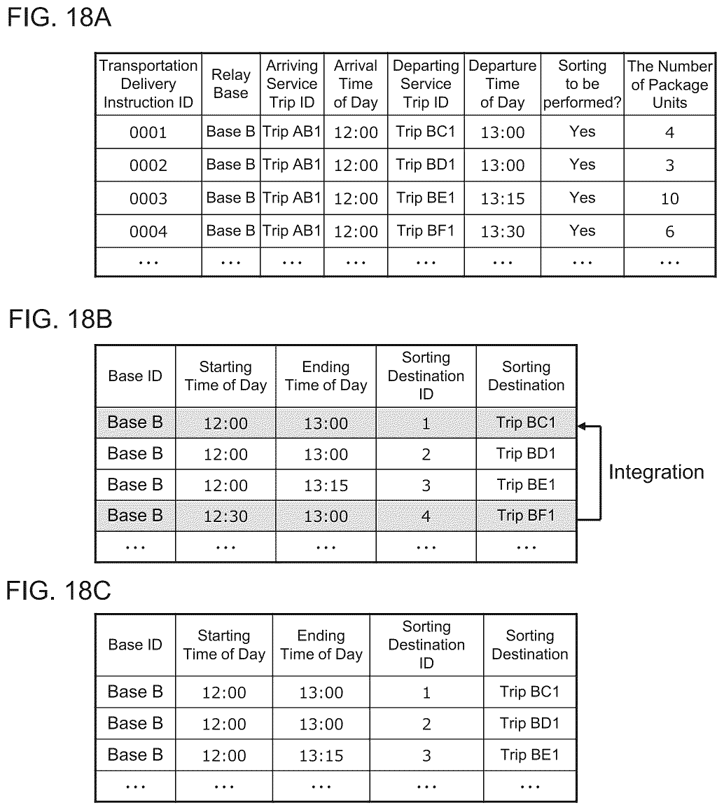

Subsequently, as illustrated in FIG. 18A, the sorting planning unit 31 extracts all pieces of information of each record, in which the base ID of the target relay base is stored in the relay base column 27B (relay information), from the respective records of the relay information table 27 (S31). Incidentally, FIG. 18A is an example in which “Base B” is the target relay base.

Next, the sorting planning unit 31 creates each sorting plan information for each piece of the relay information extracted in step S31 (S32). Specifically, as illustrated in FIG. 18B, the sorting planning unit 31 creates sorting plan information (devises a sorting plan) in which the arrival time of day in the relay information is set as the starting time of day, the departure time of day in the relay information is set as the ending time of day, and the departing service trip ID in the relay information is set as the sorting destination.

Incidentally, the sorting plan information will be created according to the following four policies (A) to (D).

(A) Regarding sorting tasks performed at the target relay base, sorting plan information is created so that all the sorting tasks will be completed by the departure time of day.

(B) The sorting tasks of all the packages arriving at the target relay base in the same service trip start at the same time.

(C) The number of sorting destinations may be limited for each time frame by setting divided time frames.

(D) If there is an upper limit quantity of packages to be sorted by the equipment and it is necessary to perform the sorting for the number of destinations larger than the above-mentioned upper limit quantity, multi-stage sorting is performed by prioritizing the packages.

In this case, the following policies (E) and (F) will be applied as the method of assigning the “priorities of packages.”

(E) Sorting of a transportation delivery instruction with the earliest departure time from the target relay base where the sorting is performed should be prioritized, so that the service trip or the next base to which the transportation delivery instruction is assigned will be assigned as a sorting destination.

(F) If there are multiple transportation delivery instructions with the same departure time of day and different sorting destinations, sorting of a transportation delivery instruction with a later arrival time of day at the target relay base and a shorter time from the arrival to the departure should be prioritized.

Incidentally, the “sorting destination(s)” in (E) and (F) refers to each assigned service trip, each base which will be the next destination, or a combination of multiple service trips and bases.

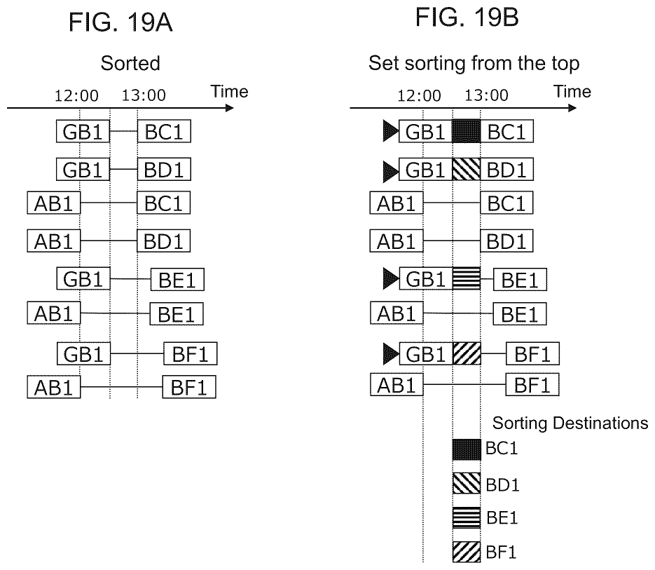

Specifically, as illustrated in FIG. 19A, the sorting planning unit 31 firstly sorts the relay information extracted in step S31 in the ascending order of the departure time of day from the target relay base according to the policy (E) described above. In this case, the sorting planning unit 31 sorts the relay information having the same departure time of day in the descending order of the arrival time of day according to the policy (F) described above.

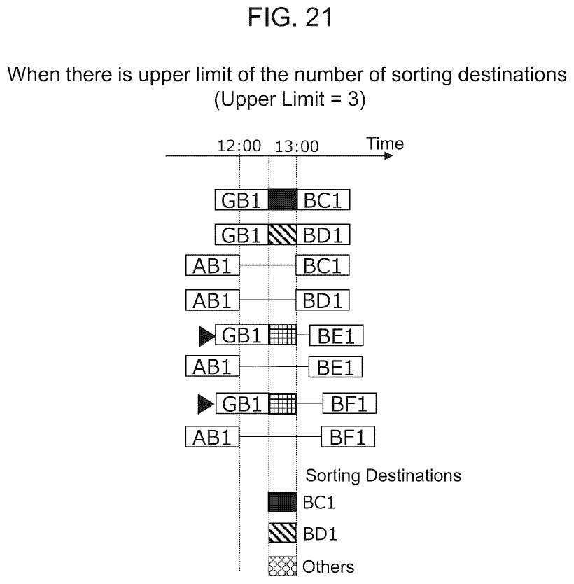

Subsequently, as illustrated in FIG. 19B, the sorting planning unit 31 sets the sorting of each piece of the sorted relay information in the ascending order of sorting. Incidentally, in FIG. 19B, it is assumed that the entire sorting work is to be completed in 30 minutes. The same applies to FIG. 21, which will be described later.

In this case, the sorting planning unit 31 sets the sorting according to the policy (E) described above. For example, in the example of FIG. 19B, since the sorting order of the relay information from the service trip “GB1” to the service trip “BC1” is the highest, the sorting from the service trip “GB1” to the service trip “BC1” is set firstly.

Moreover, according to the policy of (B) described above, the sorting planning unit 31 sets the sorting from the service trip “GB1” to the service trip “BC1” and, at the same time, also sets the sorting from the service trip “GB1” to the service trip “BD1,” the sorting from the service trip “GB1” to the service trip “BE1,” and the sorting from the service trip “GB1” to the service trip “BF1,” respectively. Consequently, in this case, the sorting is set so that the packages loaded on the service trip “GB1” are sorted into the respective service trips “BC1,” “BD1,” “BE1,” and “BF1” in the time slot from 12:30 to 13:00.

Furthermore, the sorting planning unit 31 then sets the sorting for the relay information from the service trip “AB1” to the service trip “BC1”, which has the third highest sorting order next to the relay information from the service trip “GB1” to the service trip “BC” and the relay information from the service trip “GB1” to the service trip “BD1” regarding which the sorting has already been completed. Moreover, at the same time, according to the policy of (B) described above, the sorting planning unit 31 sets the sorting from the service trip “AB1” to the service trip “BD1,” the sorting from the service trip “AB1” to the service trip “BE1,” and the sorting from the service trip “AB1” to the service trip “BF1,” respectively.

Subsequently, the sorting planning unit 31 integrates the sorting plan information, which can be integrated together, among the sorting plan information created in step S32 (S33). Specifically, as illustrated in FIG. 18B and FIG. 18C, the sorting planning unit 31 integrates such sorting plan information when there are pieces of sorting plan information which have the same sorting destination and whose time slots between the starting time of day and the ending time of day overlap with each other, among the sorting plan information. Incidentally, in this case, the sorting planning unit 31 integrates the sorting plan information by using the information having an earlier starting time of day and a later ending time of day.

Then, the sorting planning unit 31 thereby completes the first relay base sorting planning processing.

### (4-3-2) Second Relay Base Sorting Planning Processing

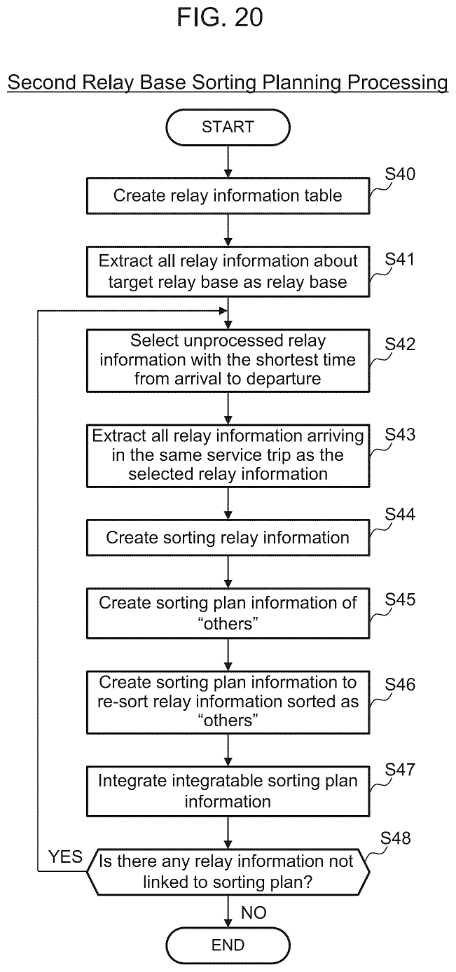

FIG. 20 illustrates an example of specific processing content of the relay base sorting planning processing executed by the sorting planning unit 31 for a relay base where the number of sorting destinations is limited (hereinafter referred to as “second relay base sorting planning processing”) in step S6 of the transportation delivery planning processing described earlier with reference to FIG. 15. The sorting planning unit 31 devises a sorting plan for the target relay base according to the processing sequence illustrated in FIG. 20.

Practically, the sorting planning unit 31 firstly creates the relay information table 27 (FIG. 10) in the same manner as steps S30 and S31 of the first relay base sorting planning processing (S40), and extracts the relay information of all the transportation delivery instructions in which the target packages go through the target relay bases from the created relay information table 27 (S41).

Subsequently, the sorting planning unit 31 selects the relay information, regarding which step S43 and its subsequent steps have not been processed and which has the shortest time from the arrival to the departure, from the relay information extracted in step S41 (S42). Moreover, the sorting planning unit 31 extracts all pieces of the relay information of the packages arriving at the target relay base in the same service trip as the service trip where the packages corresponding to the relay information selected in step S42 (hereinafter referred to as “selected relay information”), from the relay information table 27 (S43).

Next, the sorting planning unit 31 extracts the relay information of service trips including the service trip with a connecting service trip having the earliest departure time of day to the (upper limit number of sorting destinations −1)-th service trip, from the relay information extracted in step S43, and creates sorting plan information for each extracted relay information (S44).

Specifically, for example, in the case of FIG. 19A and if the upper limit quantity of packages to be sorted at the target relay base is “3,” as illustrated in FIG. 21, the sorting planning unit 31 sets the sorting plan information for the sorting from the service trip “GB1” to the service trip “BC1” and the sorting plan information for the sorting from the service trip “GB1” to the service trip “BD1.”

Furthermore, the sorting planning unit 31 creates the sorting plan information that sorts the relay information into “Others” for each relay information, for which the sorting plan information was not created in step S43, from the sorting information extracted in step S43 (S45).

For example, in the example of FIG. 21, the sorting plan information is created so that the sorting from the service trip “GB1” to the service trip “BE1” and the sorting from the service trip “GB1” to the service trip “BF1” have “Others” as the sorting destination.

Subsequently, the sorting planning unit 31 creates, for each piece of the relay information for which the sorting plan information of sorting into “Others” was created, the sorting plan information for each piece of such relay information in the same manner as in step S44 (S46). Under this circumstance, the sorting planning unit 31 delays the starting time of day of the sorting information for each piece of relay information to a later time than the starting time of day of the sorting plan information created in step S44 by the amount of sorting task time calculated by Expression (3) described earlier so that the number of destinations in the sorting plans to be processed simultaneously does not exceed the upper limit number of sorting destinations.

Moreover, if the number of pieces of the relay information based on which the sorting plan information to select “Others” as the sorting destination is larger than that of (the upper limit number of sorting destinations −1), the sorting planning unit 31 repeats the processing of steps S44 to S46 (multi-step sorting), thereby creating the sorting plan information for each piece of the relay information to select “Others” as the sorting destination in step S45.

Next, the sorting planning unit 31 integrates the sorting plan information which can be integrated among the sorting plan information created before and in step S46 in the same manner as in step S33 of the first relay base sorting planning processing (S47).

Furthermore, the sorting planning unit 31 judges whether or not there is relay information which is not linked to any sorting plan, among the relay information extracted in step S41 (step S42 and its subsequent steps have not been processed) (S48). Then, if an affirmative result is obtained in this judgment, the sorting planning unit 31 returns to step S42, and then repeats the processing of steps S42 to S48 while sequentially switching the relay information to be selected in step S42 to another piece of relay information for which step 43 and its subsequent steps have not been processed.

Then, if an affirmative result is obtained in step S48 by completing linking of the sorting plans for all the relay information extracted in step S41, the sorting planning unit 31 completes the second relay base sorting planning processing.

### (4-4) Transportation Delivery Instruction Assignment Proposal Modification Processing

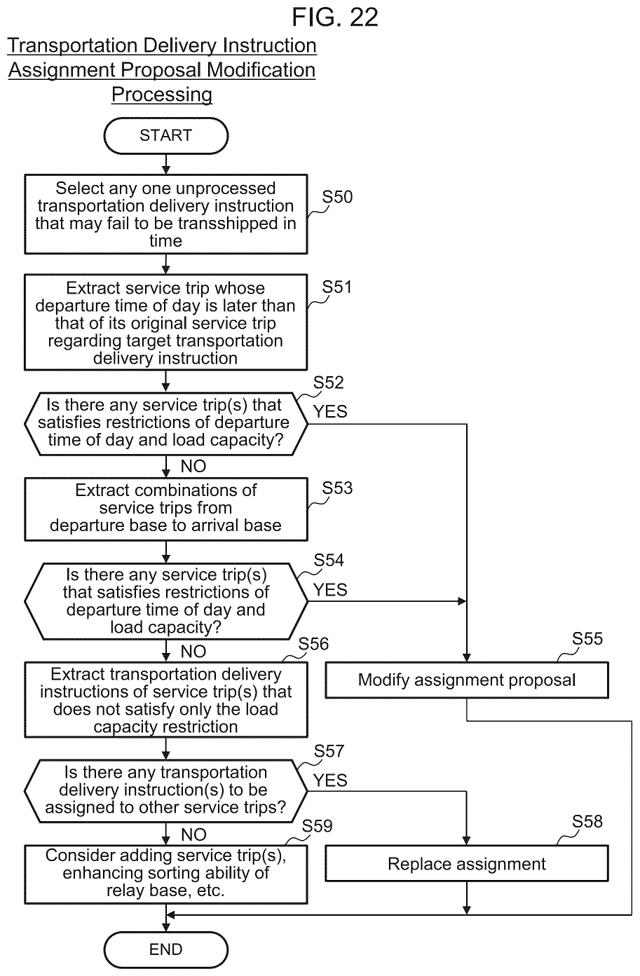

FIG. 22 illustrates an example of specific processing content of the transportation delivery instruction assignment proposal modification processing executed by the assignment proposal creation unit 30 in step S11 of the transportation delivery planning processing described earlier with reference to FIG. 15. In the processing sequence illustrated in FIG. 22, the assignment proposal creation unit 30 modifies the assignment proposal of the transportation delivery instructions which have been created according to the following policies (G) to (K).

(G) If there is a service trip that goes through the same section and will arrive at the arrival place in time by the arrival due time of day and there is any space in the load capacity, the relevant transportation delivery instruction is assigned to the service trip.

(H) If there is a service trip that goes through the same section and will arrive at the arrival place in time by the arrival due time of day and there is no space in the load capacity, the assignment of another transportation delivery instructions which is assigned to the service trip is changed and the transportation delivery instruction which will not be in time is assigned to that service trip.

(I) The relevant transportation delivery instruction is assigned to a service trip that goes through another route and satisfies the conditions.

(J) If there is a transportation delivery instruction that can be assigned to another service trip which satisfies the conditions, among the transportation delivery instructions that are to be sorted before the transportation delivery instruction that will not be completed in time, the assignment of the transportation delivery instruction is changed to a later time.

Practically, if the processing proceeds to step S11 of the transportation delivery planning processing described earlier with reference to FIG. 15, the assignment proposal creation unit 30 starts the transportation delivery instruction assignment proposal modification processing illustrated in FIG. 20, and firstly selects one arbitrary transportation delivery instruction regarding which step S51 and its subsequent steps have not been processed and the packages may fail to be transshipped in time at the target relay base described above (S50).

Subsequently, the assignment proposal creation unit 30 extracts, regarding the transportation delivery instruction selected in step S50 (hereinafter referred to as a “target transportation delivery instruction”), a service trip whose departure time of day is later than that of the original service trip, from the service trips from the target relay base to the arrival place (the combinations of direct or indirect service trips from the target relay base), (S51).

Next, the assignment proposal creation unit 30 judges whether or not there is any service trip that satisfies the constraints of the arrival time of day at the arrival place and the load capacity, among the service trips extracted in step S51 (S52). Then, if an affirmative result is obtained in this judgment, the assignment proposal creation unit 30 modifies the assignment proposal to assign the target transportation delivery instruction to any one of the service trips regarding which the affirmative result was obtained in step S52 (S55), and then completes the transportation delivery instruction assignment proposal modification processing.

On the other hand, if a negative result is obtained in the judgment of step S52, the assignment proposal creation unit 30 extracts, regarding the target transportation delivery instruction, other service trip combinations excluding the currently assigned service trip combinations from the service trip combinations from the departure place to the arrival place of the target package (S53).

Then, the assignment proposal creation unit 30 judges whether or not, among the service trip combinations extracted in step S53, there is any service trip combination that satisfies the constraints of (or requirements for) the arrival time of day and the load capacity of the package in the target transportation delivery instruction (S54).

Then, if an affirmative result is obtained in this judgment, the assignment proposal creation unit 30 modifies the assignment proposal to assign the target transportation delivery instruction to any one of the service trip combinations among the service trip combinations that satisfy the constraints of the arrival time of day and the load capacity of the package in the target transportation delivery instruction detected in step S54 (S55); and the assignment proposal creation unit 30 then completes this transportation delivery instruction assignment proposal modification processing.

On the other hand, if a negative result is obtained in the judgment of step S54, the assignment proposal creation unit 30 extracts all the transportation delivery instructions that do not satisfy only the load capacity constraint (S56). Then, the assignment proposal creation unit 30 judges whether or not there is any transportation delivery instruction that can be assigned to another service trip assigned to another transportation delivery instruction (combination of direct and indirect service trips), among the extracted transportation delivery instructions (S57).

Then, if an affirmative result is obtained in this judgment, the assignment proposal creation unit 30 replaces the transportation delivery instruction extracted in step S56 with the transportation delivery instruction extracted in step S57 (S58), and then completes this transportation delivery instruction assignment proposal modification processing.

On the other hand, if a negative result is obtained in the judgment of step S57, the assignment proposal creation unit 30 examines a counterplan to allow all the packages to arrive at the arrival place before the arrival due time of day by, for example, adding service trips or enhancing the sorting ability of the target relay base (for example, by adding temporary workers), and modifies the assignment proposal on the premise of such a counterplan (S59). Then, the assignment proposal creation unit 30 completes this transportation delivery instruction assignment proposal modification processing. Incidentally, in this case, the counterplan is displayed on the transportation delivery planning instruction screen 40, 60.

### (5) Advantageous Effects of this Embodiment

The transportation delivery planning apparatus 6 according to this embodiment as described above devises a transportation delivery plan in which each transportation delivery instruction is assigned to a service trip, evaluates the transportation delivery plan in consideration of the package sorting ability at each relay base on the route from the departure place to the arrival place of each package, and modifies the transportation delivery plan as necessary to ensure that all the packages at the relay base will be in time for the connecting service trips based on the evaluation result.

Therefore, with the transportation delivery planning apparatus 6 according to the present invention, it is possible to devise a transportation delivery plan in consideration of the task time at the relay base and to prevent the occurrence of the situation where packages fail to be loaded into connecting service trips due to, for example, a delay in the task at the relay base. Therefore, the transportation delivery planning apparatus 6 can suppress the occurrence of delayed delivery of packages.

### (6) Other Embodiments

Incidentally, the aforementioned embodiment has described the case where the transportation delivery planning apparatus 6 is configured by one computer device, however, the present invention is not limited to this example and the transportation delivery planning apparatus 6 may be configured by, for example, a distributed computing system composed of a plurality of computer devices.

Moreover, the aforementioned embodiment has described the case where the transportation delivery planning instruction screens 40 and 60 are configured as illustrated in FIG. 12 and FIG. 14; however, the present invention is not limited to this example and other wide varieties of screen configurations can be applied. In this case, the sorting plan at each relay base may be displayed in a more easily understandable manner, for example, as illustrated in FIG. 19B.

Furthermore, in the aforementioned embodiment has described the case where the sorting control system 4 controls the sorting equipment at the relay base according to the sorting plan devised by the transportation delivery planning apparatus 6; however, the present invention is not limited to this example and the transportation delivery planning apparatus 6 may control the sorting equipment at the relay base according to the sorting plan devised by itself.

### INDUSTRIAL APPLICABILITY

The present invention can be applied to a wide variety of transportation and delivery planning apparatuses with various configurations where the transportation delivery plan is devised to assign transportation delivery instructions regarding respective packages to service trips.

### REFERENCE SIGNS LIST

1: transportation delivery planning system
2: transportation delivery instruction management system
3: service trip management system
4: sorting control system
6: transportation delivery planning apparatus
10: CPU
13: input device
14: display device
20: service trip information table
21: fare table
22: base information table
23: base sorting ability information table
24: transportation delivery instruction information table
25: assignment information table
26: priority index information table
27: relay information table
28: sorting plan information table
30: assignment proposal creation unit
31: sorting planning unit
32: evaluation determination unit
40: transportation delivery planning instruction screen
50: popup

1. A transportation and delivery planning apparatus for devising a transportation delivery plan to assign transportation delivery instructions regarding respective packages to service trips,
the transportation and delivery planning apparatus comprising:
an assignment proposal creation unit that creates an assignment proposal to assign each of the transportation delivery instructions to each of the service trips for which a service plan was created in advance;
a sorting planning unit that devises a sorting plan for the packages at a relay base on the basis of the assignment proposal for each transportation delivery instruction created by the assignment proposal creation unit; and
an evaluation determination unit that calculates task time of a sorting task at the relay base according to the sorting plan and evaluates the transportation delivery plan based on a calculation result,
wherein the sorting planning unit changes the sorting plan or the assignment proposal creation unit modifies the assignment proposal, based on an evaluation result of the evaluation determination unit, so that the sorting task for the respective packages will be completed at the relay base before a departure of the service trip for a connecting destination assigned to each of the transportation delivery instructions.

2. The transportation and delivery planning apparatus according to claim 1,
wherein the assignment proposal creation unit creates the assignment proposal according to a specified optimization method using a previously designated index as an objective variable.

3. The transportation and delivery planning apparatus according to claim 1,
wherein the evaluation determination unit calculates the sorting time by using a calculation method according to a package sorting ability to sort the packages at the relay base.

4. The transportation and delivery planning apparatus according to claim 3,
wherein the evaluation determination unit calculates the sorting time by using the calculation method according to the package sorting ability at the relay base, depending on whether the package sorting ability at the relay base corresponds to any one of following cases: a case where the sorting time varies according to a quantity of packages to be processed simultaneously; a case where the sorting time varies according to the quantity of packages to be processed simultaneously and a number of destinations; and a case where the sorting time varies according to the quantity of packages to be processed simultaneously, the number of destinations, and an upper limit quantity of packages to be sorted by sorting equipment.

5. The transportation and delivery planning apparatus according to claim 3,
wherein the evaluation determination unit calculates the sorting time by using the calculation method according to the package sorting ability at the relay base, depending on either a case where the package sorting ability changes depending on a time slot or a case where the package sorting ability does not change depending on the time slot.

6. The transportation and delivery planning apparatus according to claim 1,
wherein the evaluation determination unit displays the assignment proposal and the sorting plan which are finally obtained.

7. A transportation and delivery planning method executed by a transportation and delivery planning apparatus for devising a transportation delivery plan to assign transportation delivery instructions regarding respective packages to service trips,
the transportation and delivery planning method comprising:
a first step of creating an assignment proposal to assign each of the transportation delivery instructions to each of the service trips for which a service plan was created in advance;
a second step of devising a sorting plan for the packages at a relay base on the basis of the created assignment proposal for each transportation delivery instruction; and
a third step of calculating task time of a sorting task at the relay base according to the sorting plan and evaluating the transportation delivery plan based on a calculation result, a fourth step of changing the sorting plan or modifying the assignment proposal, based on an evaluation result of the transportation delivery plan, so that the sorting task for the respective packages will be completed at the relay base before a departure of the service trip for a connecting destination assigned to each of the transportation delivery instructions.

8. The transportation and delivery planning method according to claim 7,
wherein in the first step, the transportation and delivery planning apparatus creates the assignment proposal according to a specified optimization method using a previously designated index as an objective variable.

9. The transportation and delivery planning method according to claim 7,
wherein in the third step, the transportation and delivery planning apparatus calculates the sorting time by using a calculation method according to a package sorting ability to sort the packages at the relay base.

10. The transportation and delivery planning method according to claim 9,
wherein in the third step, the transportation and delivery planning apparatus calculates the sorting time by using the calculation method according to the package sorting ability at the relay base, depending on whether the package sorting ability at the relay base corresponds to any one of following cases: a case where the sorting time varies according to a quantity of packages to be processed simultaneously; a case where the sorting time varies according to the quantity of packages to be processed simultaneously and a number of destinations; and a case where the sorting time varies according to the quantity of packages to be processed simultaneously, the number of destinations, and an upper limit quantity of packages to be sorted by sorting equipment.

11. The transportation and delivery planning method according to claim 9,
wherein in the third step, the transportation and delivery planning apparatus calculates the sorting time by using the calculation method according to the package sorting ability at the relay base, depending on either a case where the package sorting ability changes depending on a time slot or a case where the package sorting ability does not change depending on the time slot.

12. The transportation and delivery planning method according to claim 7,
wherein in the third step, the transportation and delivery planning apparatus displays the assignment proposal and the sorting plan which are finally obtained.
